(19) United States
(12) Patent Application Publication
(10) Pub. No.: US 2026/0162900 A1
(43) Pub. Date: Jun. 11, 2026

(54) MULTILAYER CERAMIC ELECTRONIC COMPONENT

(71) Applicant: Murata Manufacturing Co., Ltd., Nagaokakyo-shi (JP)

(72) Inventors: Takashi SAWADA, Nagaokakyo-shi (JP); Masahiro SAKURATANI, Nagaokakyo-shi (JP); Tomohiro SASAKI, Nagaokakyo-shi (JP)

(21) Appl. No.: 19/538,249

(22) Filed: Feb. 12, 2026

Related U.S. Application Data
(63) Continuation of application No. PCT/JP2024/013808, filed on Apr. 3, 2024.

(30) Foreign Application Priority Data
Sep. 7, 2023 (JP) 2023-145118

(51) Int. Cl. H01G 4/242; H01G 4/30

(52) U.S. Cl. CPC H01G 4/242; H01G 4/30

(57) ABSTRACT

A multilayer ceramic electronic component includes a multilayer ceramic capacitor including a laminate and at least four external electrodes, the laminate including first and second main surfaces, first and second surfaces opposing each other in a first direction, and third and fourth surfaces opposing each other in a second direction, the at least four external electrodes being on any of the first, second, third, and fourth surfaces, and a junction electrode on the first or second main surface and electrically connecting at least two of the external electrodes of a same potential. When a DC resistance of the multilayer ceramic capacitor is Rdc1 and a DC resistance of the junction electrode is Rdc3, Rdc1≤Rdc3.

### CROSS REFERENCE TO RELATED APPLICATIONS

This application claims the benefit of priority to Japanese Patent Application No. 2023-145118 filed on Sep. 7, 2023 and is a Continuation Application of PCT Application No. PCT/JP2024/013808 filed on Apr. 3, 2024. The entire contents of each application are hereby incorporated herein by reference.

### BACKGROUND OF THE INVENTION

### 1. Field of the Invention

The present invention relates to multilayer ceramic electronic components.

### 2. Description of the Related Art

For example, feedthrough three-terminal capacitors have been known as decoupling capacitors used to stabilize a power supply voltage supplied to an integrated circuit component (IC) that operates at high speed, and as noise countermeasure components of a power supply line supplied to an integrated circuit component (IC). Such feedthrough three-terminal capacitors each generally include a multilayer body including a first main surface and a second main surface opposed to each other, a first lateral surface and a second lateral surface opposed to each other, and a first end surface and a second end surface opposed to each other. The multilayer body includes a plurality of first internal electrode layers and a plurality of second internal electrode layers alternately provided in the lamination direction therein. The plurality of first internal electrode layers each include two ends respectively extending toward the first end surface and the second end surface, and the plurality of second internal electrode layers each include two ends respectively extending toward the first lateral surface and the second lateral surface. Further, the plurality of first internal electrode layers are each connected to a first external electrode and a second external electrode, and the plurality of second internal electrode layers are each connected to a third external electrode and a fourth external electrode.

When a general feedthrough three-terminal capacitor is used as a noise filter, a DC current flows through the signal internal electrode (first internal electrode layer). However, when the capacitance becomes low, the number of signal internal electrodes (first internal electrode layers) becomes fewer and DC resistance increases. This causes a problem in that the heat generated from the capacitor increases.

In this regard, a configuration such as that disclosed in Japanese Unexamined Patent Application Publication No. H9-55335 has been provided as a configuration of a low-capacitance feedthrough three-terminal capacitor which is able to reduce or prevent an increase in DC resistance, while reducing or preventing an increase in electrostatic capacitance. When the number of signal internal electrodes (first internal electrode layers) is increased and the signal internal electrodes (first internal electrode layers) are opposed to each other, both of the electrostatic capacitance and the DC resistance are reduced or prevented.

However, such a configuration disclosed in Japanese Unexamined Patent Application Publication No. H9-55335 has the following problem. That is, there is a limitation in increasing the number of signal internal electrodes (first internal electrode layers) within a predetermined size constraint, and it is difficult to handle even larger current.

### SUMMARY OF THE INVENTION

Example embodiments of the present invention provide multilayer ceramic electronic components that are each able to handle a larger current.

A multilayer ceramic electronic component according to an example embodiment of the present invention includes a multilayer ceramic capacitor including a multilayer body including a first main surface and a second main surface opposed to each other in a lamination direction, a first surface and a second surface opposed to each other in a first direction orthogonal or substantially orthogonal to the lamination direction, and a third surface and a fourth surface opposed to each other in a second direction orthogonal or substantially orthogonal to the lamination direction and the first direction, and at least four external electrodes on any one of the first surface, the second surface, the third surface, or the fourth surface, and a joining electrode on either one of the first main surface or the second main surface and electrically joining at least two external electrodes of the same potential among the at least four external electrodes, in which, when a DC resistance of the multilayer ceramic capacitor is defined as Rdc1 and a DC resistance of the joining electrode is defined as Rdc3, Rdc1≤Rdc3 is satisfied.

According to a multilayer ceramic electronic component according to an example embodiment of the present invention, on either one of the first main surface or the second main surface, a joining electrode that electrically joins at least two external electrodes having the same potential among the external electrodes is provided, and when a DC resistance of the multilayer ceramic capacitor is defined as Rdc1 and a DC resistance of the joining electrode is defined as Rdc3, Rdc1≤Rdc3 is satisfied, such that a combined resistance of the multilayer ceramic capacitor and the joining electrode becomes smaller than a resistance of the multilayer ceramic capacitor alone, and thus multilayer ceramic electronic components that are each able to handle a larger current are provided.

According to example embodiments of the present invention, multilayer ceramic electronic components that are each able to handle a larger current are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view showing a multilayer ceramic electronic component according to a first example embodiment of the present invention.

FIG. 2 is a front view of the multilayer ceramic electronic component according to the first example embodiment of the present invention.

FIG. 3 is a plan view of the multilayer ceramic electronic component according to the first example embodiment of the present invention.

FIG. 4 is a cross-sectional view taken along the line IV-IV of FIG. 1.

FIG. 5 is a cross-sectional view taken along the line V-V of FIG. 1.

FIG. 6 is a cross-sectional view taken along the line VI-VI of FIG. 4.

FIG. 7 is a cross-sectional view taken along the line VII-VII of FIG. 4.

FIG. 8 is an external perspective view of a multilayer ceramic electronic component according to a modified example of the first example embodiment of the present invention.

FIG. 9 is a cross-sectional view in the lamination direction showing a mounting structure of the multilayer ceramic electronic component according to the first example embodiment of the present invention.

FIG. 10 is a cross-sectional view in a second direction showing a mounting structure of the multilayer ceramic electronic component according to the first example embodiment of the present invention.

FIG. 11 is a cross-sectional view showing a first modified example of a multilayer ceramic capacitor according to the first example embodiment of the present invention, corresponding to the cross-sectional view of FIG. 4.

FIG. 12 is a cross-sectional view showing the first modified example of the multilayer ceramic capacitor according to the first example embodiment of the present invention, corresponding to the cross-sectional view of FIG. 5.

FIG. 13 is a cross-sectional view taken along the line XIII-XIII of FIG. 11.

FIG. 14 is a cross-sectional view taken along the line XIV-XIV of FIG. 11.

FIG. 15 is a cross-sectional view showing a second modified example of a multilayer ceramic capacitor according to the first example embodiment of the present invention, corresponding to the cross-sectional view of FIG. 4.

FIG. 16 is a cross-sectional view showing the second modified example of the multilayer ceramic capacitor according to the first example embodiment of the present invention, corresponding to the cross-sectional view of FIG. 5.

FIG. 17 is an external perspective view showing a multilayer ceramic electronic component according to a second example embodiment of the present invention.

FIG. 18 is a front view of the multilayer ceramic electronic component according to the second example embodiment of the present invention.

FIG. 19 is a lateral view of the multilayer ceramic electronic component according to the second example embodiment of the present invention.

FIG. 20 is a plan view of the multilayer ceramic electronic component according to the second example embodiment of the present invention.

FIG. 21 is a cross-sectional view taken along the line XXI-XXI of FIG. 17.

FIG. 22 is a cross-sectional view taken along the line XXII-XXII of FIG. 17.

FIG. 23 is a cross-sectional view taken along the line XXI-XXI of FIG. 17.

FIG. 24 is a cross-sectional view taken along the line XXIV-XXIV of FIG. 17.

FIG. 25 is a cross-sectional view taken along the line XXV-XXV of FIG. 17.

FIG. 26 is an exploded perspective view of the multilayer body shown in FIG. 17.

### DETAILED DESCRIPTION OF THE EXAMPLE EMBODIMENTS

Example embodiments of the present invention are described in detail below with reference to the drawings.

A multilayer ceramic electronic component 100 according to an example embodiment of the present invention will be described.

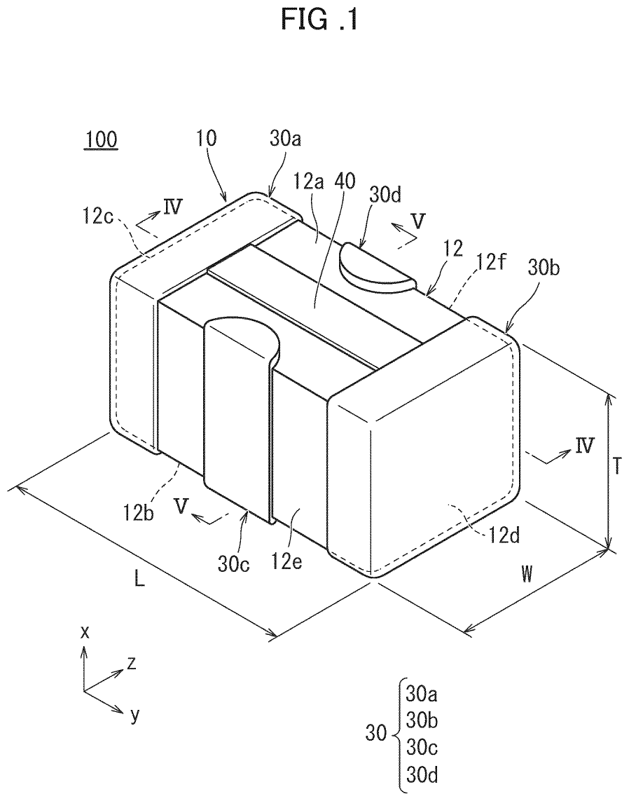

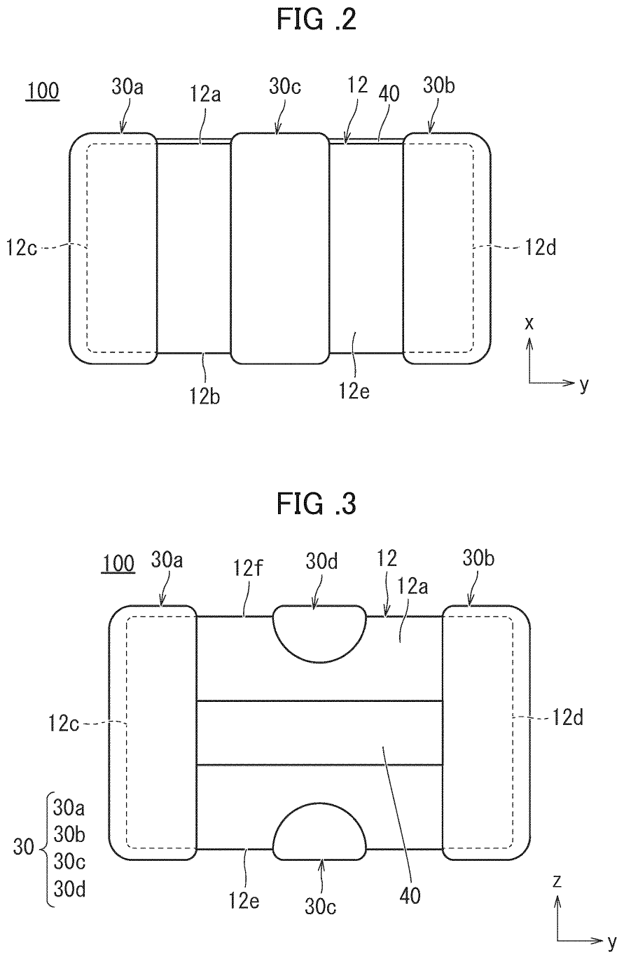

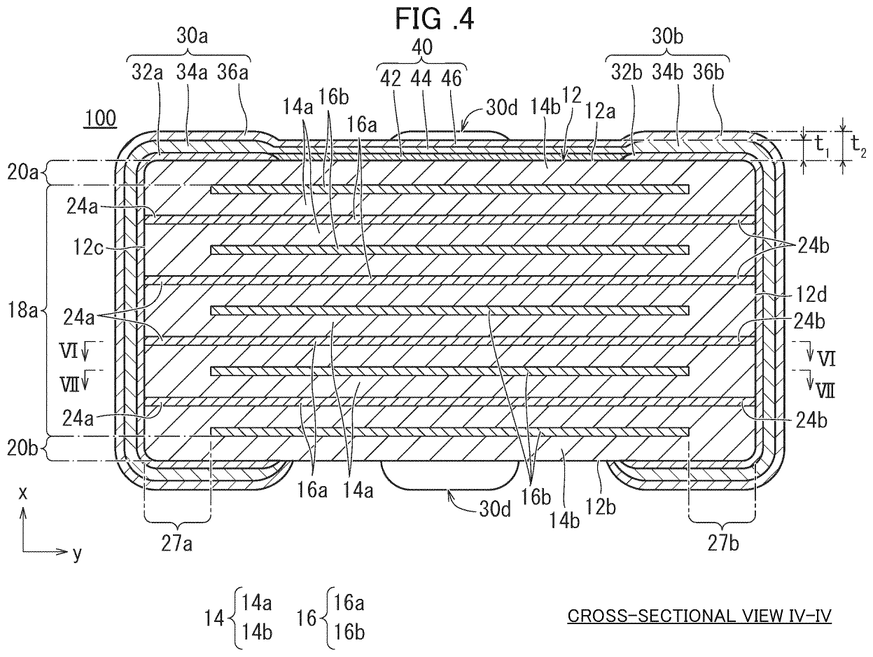

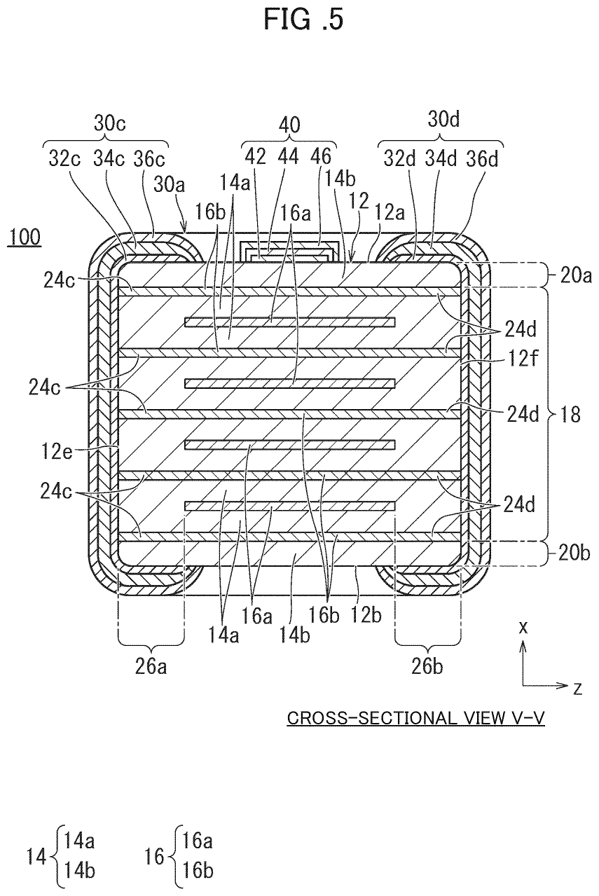

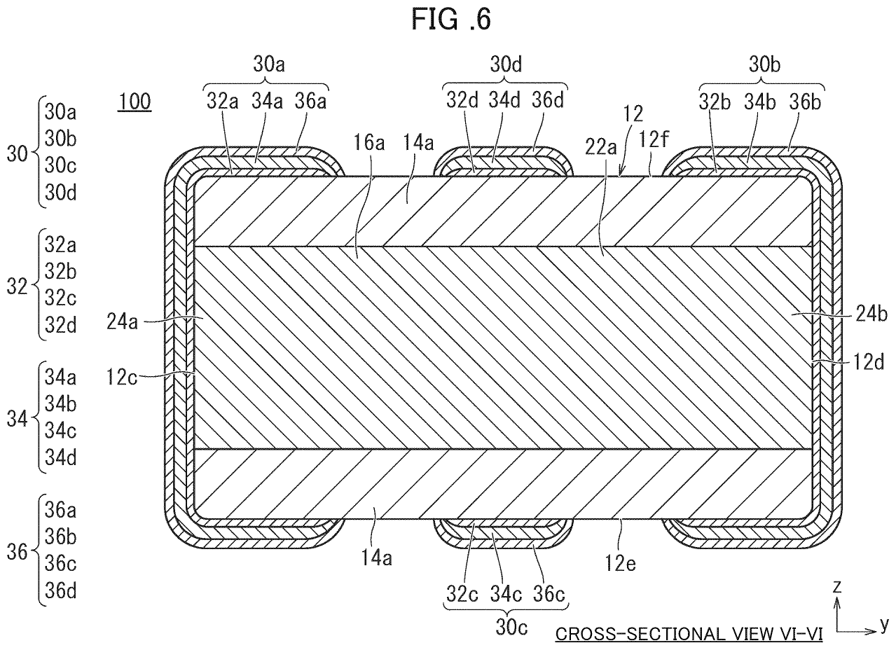

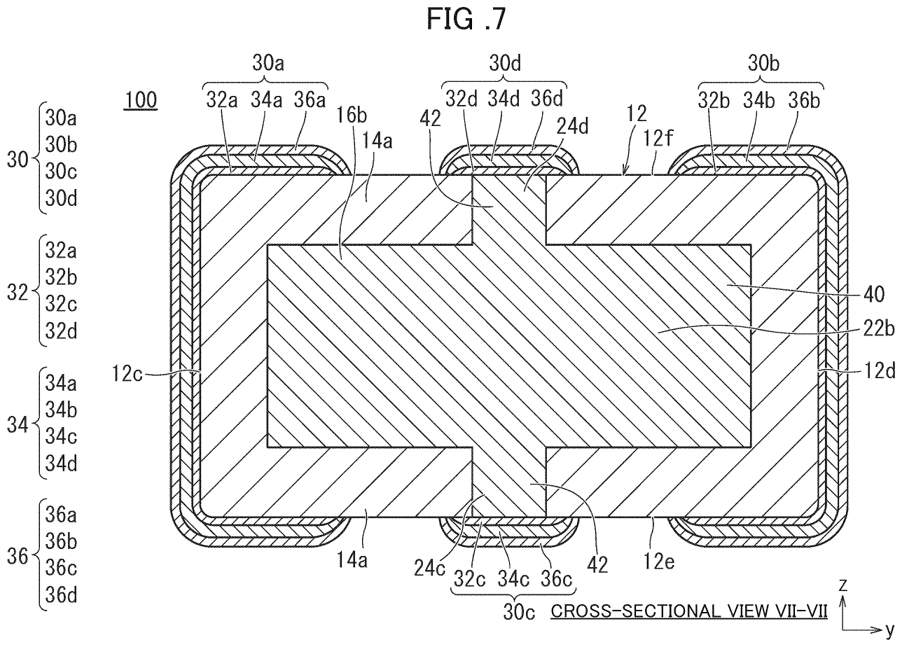

FIG. 1 is an external perspective view showing a multilayer ceramic electronic component according to a first example embodiment of the present invention. FIG. 2 is a front view of the multilayer ceramic electronic component according to the first example embodiment of the present invention. FIG. 3 is a plan view of the multilayer ceramic electronic component according to the first example embodiment of the present invention. FIG. 4 is a cross-sectional view taken along the line IV-IV of FIG. 1. FIG. 5 is a cross-sectional view taken along the line V-V of FIG. 1. FIG. 6 is a cross-sectional view taken along the line VI-VI of FIG. 4. FIG. 7 is a cross-sectional view taken along the line VII-VI of FIG. 4.

As shown in FIGS. 1 to 3, the multilayer ceramic electronic component 100 according to the first example embodiment of the present invention includes a multilayer ceramic capacitor 10 and a joining electrode 40.

A multilayer ceramic capacitor 10 according to an example embodiment of the present invention will be described. The multilayer ceramic capacitor 10 includes a multilayer body 12 and a plurality of external electrodes 30.

The multilayer body 12 includes a first main surface 12a and a second main surface 12b opposed to each other in a lamination direction x, a first surface 12c and a second surface 12d opposed to each other in a first direction y orthogonal or substantially orthogonal to the lamination direction x, and a third surface 12e and a fourth surface 12f opposed to each other in a second direction orthogonal or substantially orthogonal to the lamination direction x and the first direction y. The direction connecting the first main surface 12a and the second main surface 12b of the multilayer body 12 corresponds to the lamination direction x.

The multilayer body 12 has a rectangular or substantially rectangular parallelepiped shape. The multilayer body 12 is preferably rounded at corner portions and ridge portions. The corner portions refer to portions where three adjacent surfaces of the multilayer body 12 intersect, and the ridge portions refer to portions where two adjacent surfaces of the multilayer body 12 intersect. Surface irregularities and the like may be provided on a portion or all of the first main surface 12a and the second main surface 12b, the first surface 12c and the second surface 12d, and the third surface 12e and the fourth surface 12f.

The multilayer body 12 includes a plurality of dielectric layers 14 and a plurality of internal electrodes 16. The dielectric layers 14 include inner dielectric layers 14a and outer dielectric layers 14b. The internal electrodes 16 include first internal electrodes 16a and second internal electrodes 16b.

The multilayer body 12 includes an inner layer portion 18, a first outer layer portion 20a located adjacent to the first main surface 12a, and a second outer layer portion 20b located adjacent to the second main surface 12b.

The first outer layer portion 20a is located adjacent to the first main surface 12a of the multilayer body 12, and is an aggregate of a plurality of outer dielectric layers 14b located between the first main surface 12a and an internal electrode 16 closest to the first main surface 12a.

The second outer layer portion 20b is located adjacent to the second main surface 12b of the multilayer body 12, and is an aggregate of a plurality of outer dielectric layers 14b located between the second main surface 12b and an internal electrode 16 closest to the second main surface 12b.

The region sandwiched between the first outer layer portion 20a and the second outer layer portion 20b corresponds to the inner layer portion 18.

The inner layer portion 18 includes first internal electrodes 16a each including one end exposed at the first surface 12c and the other end exposed at the second surface 12d, second internal electrodes 16b each including one end exposed at the third surface 12e and the other end exposed at the fourth surface 12f, and inner dielectric layers 14a.

As a material of the dielectric layers 14, for example, a dielectric material can be used. As the dielectric material, for example, dielectric ceramics including main components such as BaTiO₃, CaTiO₃, SrTiO₃, CaZrO₃, or the like can be used. Materials obtained by adding subcomponents such as, for example, Mn compounds, Fe compounds, Cr compounds, Co compounds, Ni compounds, or the like to these main components may also be used. The inner dielectric layers 14a and the outer dielectric layers 14b may be made of the same dielectric material, or may be made of different dielectric materials in order to separate functions between the inner layer portion 18 and the outer layer portions 20a and 20b. At least one of, for example, Si, Mg, Ba, or Mn may be added as an additive material. The additive material is present between ceramic particles.

It is possible for the inner dielectric layers 14a to make dielectric breakdown occurring between the first internal electrodes 16a and the second internal electrodes 16b less likely to occur when they include a large amount of CaTiO₃ or CaZrO₃ as dielectric components, for example. Without being limited thereto, the inner dielectric layers 14a may include, for example, SrTiO₃ or the like as a main component. Separately from this, in order to increase the capacitance of the multilayer ceramic capacitor 10, it is preferred that the inner dielectric layers 14a are made of a material having a high permittivity, for example, BaTiO₃ or the like.

The dielectric layers 14 may include a plurality of crystal grains including a perovskite compound having BaTiO₃ as a basic structure, for example.

Since the capacitance of a capacitor becomes larger as the thickness of the dielectric layers 14 is thinner, the crystal grain size is preferably, for example, about 1 μm or less.

The number of the laminated dielectric layers 14 is not particularly limited, but is preferably, for example, 5 or more and 1000 or less including those in the first outer layer portion 20a and the second outer layer portion 20b. The thickness of each of the dielectric layers 14 is preferably about 0.3 μm or more and about 6.0 μm or less, for example.

The internal electrodes 16 include first internal electrodes 16a and second internal electrodes 16b. The first internal electrodes 16a and the second internal electrodes 16b are alternately laminated with the inner dielectric layers 14a interposed therebetween.

The first internal electrodes 16a are each provided on a surface of a corresponding one of the inner dielectric layers 14a. Each of the first internal electrodes 16a includes a first counter electrode portion 22a that is opposed to the first main surface 12a and the second main surface 12b and is opposed to the second internal electrodes 16b, a first extension electrode portion 24a that is connected to the first counter electrode portion 22a and extends toward the first surface 12c, and a second extension electrode portion 24b that is connected to the first counter electrode portion 22a and extends toward the second surface 12d.

The shape of each of the first counter electrode portions 22a of the first internal electrodes 16a is not particularly limited, but is preferably rectangular or substantially rectangular in a plan view. The first counter electrode portion 22a may include rounded corner portions or obliquely shaped (tapered) corner portions in a plan view. Further, the first counter electrode portion 22a may also be sloped and tapered in either direction in a plan view.

The shapes of the first extension electrode portion 24a and the second extension electrode portion 24b of the first internal electrodes 16a are not particularly limited, but are preferably rectangular or substantially rectangular in a plan view. However, the corner portions in a plan view may be rounded, or the corner portions may be formed obliquely in a plan view (tapered shape). Alternatively, each of the first extension electrode portion 24a and the second extension electrode portion 24b may have a tapered shape in a plan view which is sloped toward either side.

The second internal electrodes 16b are each provided on a surface of a corresponding one of the inner dielectric layers 14a different from the inner dielectric layers 14a on which the first internal electrodes 16a are respectively provided. Each of the second internal electrodes 16b includes a second counter electrode portion 22b that is opposed to the first internal electrodes 16a, a third extension electrode portion 24c that is connected to the second counter electrode portion 22b and extends toward the third surface 12e, and a fourth extension electrode portion 24d that is connected to the second counter electrode portion 22b and extends toward the fourth surface 12f.

The shape of each of the second counter electrode portions 22b of the second internal electrodes 16b is not particularly limited, but is preferably rectangular or substantially rectangular in a plan view. The second counter electrode portions 22b may include rounded corner portions or obliquely shaped (tapered) corner portions in a plan view. Further, the second counter electrode portions 22b may also be sloped and tapered in either direction in a plan view.

The shapes of the third extension electrode portion 24c and the fourth extension electrode portion 24d of the second internal electrodes 16b are not particularly limited, but are preferably rectangular or substantially rectangular in a plan view. However, the corner portions in a plan view may be rounded, or the corner portions may be formed obliquely in a plan view (tapered shape). Alternatively, each of the third extension electrode portion 24c and the fourth extension electrode portion 24d may have a tapered shape in a plan view which is sloped toward either side.

The multilayer body 12 includes a side portion (W gap) 26a of the multilayer body 12 located between one end of each of the first counter electrode portions 22a of the first internal electrodes 16a and the second counter electrode portions 22b of the second internal electrodes 16b in the second direction z and the third surface 12e, and a side portion (W gap) 26b of the multilayer body 12 located between one end of each of the first counter electrode portions 22a of the first internal electrodes 16a and the second counter electrode portions 22b of the second internal electrodes 16b in the second direction z and the fourth surface 12f.

The multilayer body 12 includes an end portion (L gap) 27a of the multilayer body 12 located between one end of each of the first counter electrode portions 22a of the first internal electrodes 16a and the second counter electrode portions 22b of the second internal electrodes 16b in the first direction y and the first surface 12c, and an end portion (L gap) 27b of the multilayer body 12 located between one end of each of the first counter electrode portions 22a of the first internal electrodes 16a and the second counter electrode portions 22b of the second internal electrodes 16b in the first direction y and the second surface 12d.

The first internal electrodes 16a and the second internal electrodes 16b may each include an appropriate electrically conductive material, such as, for example, a metal such as Ni, Cu, Ag, Pd, or Au or an alloy including at least one of them, such as a Ni—Cu alloy or an Ag—Pd alloy, but are not limited thereto. The first internal electrodes 16a and the second internal electrodes 16b may include the same electrically conductive material or may include different electrically conductive materials.

By including, for example, Sn in the first internal electrodes 16a and the second internal electrodes 16b, the potential barrier height at the interface between the internal electrodes 16 and the dielectric layers 14 is increased, electric field concentration at the interface between the internal electrodes 16 and the dielectric layers 14 can be reduced, and high-temperature load reliability is improved. At this time, Sn can sufficiently provide its effect even when included in only one of the first internal electrodes 16a or the second internal electrodes 16b.

The total number of the first internal electrodes 16a and the second internal electrodes 16b is preferably, for example, 2 or more and 1000 or less. The thickness of each of the first internal electrodes 16a and the second internal electrodes 16b is not particularly limited, but is preferably, for example, about 0.3 μm or more and about 6.0 μm or less.

The external electrodes 30 include a plurality of external electrodes 30 connected to the first internal electrodes 16a and the second internal electrodes 16b. The external electrodes 30 include a first external electrode 30a, a second external electrode 30b, a third external electrode 30c, and a fourth external electrode 30d.

The first external electrode 30a is provided on the first surface 12c and is connected to the first internal electrodes 16a. Further, the first external electrode 30a may also be provided on a portion of the first main surface 12a and a portion of the second main surface 12b, and a portion of the third surface 12e and a portion of the fourth surface 12f.

The second external electrode 30b is provided on the second surface 12d and is connected to the first internal electrodes 16a. Further, the second external electrode 30b may also be provided on a portion of the first main surface 12a and a portion of the second main surface 12b, and a portion of the third surface 12e and a portion of the fourth surface 12f.

The third external electrode 30c is provided on the third surface 12e and is connected to the second internal electrodes 16b. Further, the third external electrode 30c may also be provided on a portion of the first main surface 12a and a portion of the second main surface 12b.

The fourth external electrode 30d is provided on the fourth surface 12f and is connected to the second internal electrodes 16b. Further, the fourth external electrode 30d may also be provided on a portion of the first main surface 12a and a portion of the second main surface 12b.

Although not illustrated, the first external electrode 30a to the fourth external electrode 30d are provided on the first main surface 12a or the second main surface 12b, but may not be provided on either one of the main surfaces. In this case, it is possible to reduce the dimension of the multilayer ceramic capacitor 10 in the lamination direction x, and it is possible to make the multilayer ceramic capacitor 10 thinner.

In the multilayer body 12, capacitance is generated between the first counter electrode portions 22a of the first internal electrodes 16a and the second counter electrode portions 22b of the second internal electrodes 16b, which are opposed to each other with the inner dielectric layers 14a interposed therebetween. Therefore, capacitance can be generated between the first external electrode 30a and the second external electrode 30b connected to the first internal electrodes 16a and the third external electrode 30c and the fourth external electrode 30d connected to the second internal electrodes 16b to realize capacitor characteristics.

The first external electrode 30a, the second external electrode 30b, the third external electrode 30c, and the fourth external electrode 30d each preferably include a base electrode layer 32 and a plated layer. The plated layer preferably includes a lower plated layer 34 and an upper plated layer 36.

In other words, the first external electrode 30a preferably includes a first base electrode layer 32a, a first lower plated layer 34a, and a first upper plated layer 36a. The second external electrode 30b preferably includes a second base electrode layer 32b, a second lower plated layer 34b, and a second upper plated layer 36b. The third external electrode 30c preferably includes a third base electrode layer 32c, a third lower plated layer 34c, and a third upper plated layer 36c. The fourth external electrode 30d preferably includes a fourth base electrode layer 32d, a fourth lower plated layer 34d, and a fourth upper plated layer 36d.

The base electrode layer 32 includes at least one of, for example, a fired layer, an electrically conductive resin layer, a thin film layer, or the like.

First, a case where the base electrode layer 32 is provided as a fired layer will be described. The fired layer includes a metal component and a glass component. The glass component includes at least one of, for example, B, Si, Ba, Mg, Al, Li, or the like. Further, as the metal component of the fired layer, for example, at least one of Cu, Ni, Ag, Pd, Ag—Pd alloys, Au, or the like may be included. Further, the fired layer may include a plurality of layers.

Further, when the base electrode layer 32 is provided as a fired layer, the base electrode layer 32 may include the same types of components as the dielectric layers 14 and a metal. In this case, for example, if the dielectric layers 14 are made of a CaZrO-based material, the same types of components are Ca and Zr.

The fired layer is obtained by applying an electrically conductive paste including a glass component and a metal component to the multilayer body 12, and firing it. The fired layer may be obtained by simultaneously firing a multilayer chip including the internal electrodes 16 and the dielectric layers 14 and an electrically conductive paste applied to the multilayer chip, or may be obtained by firing the multilayer chip including the internal electrodes 16 and the dielectric layers 14 to obtain the multilayer body 12, followed by applying the electrically conductive paste, and firing it. When simultaneously firing the multilayer chip including the internal electrodes 16 and the dielectric layers 14 and the electrically conductive paste applied to the multilayer chip, it is preferable to add a dielectric component instead of the glass component, or to add both of a dielectric component and a glass component in the fired layer.

The thickness (end surface middle thickness) of each of the first fired layer and the second fired layer provided on the first surface 12c and the second surface 12d in the first direction y connecting the first surface 12c and the second surface 12d at a middle portion in the lamination direction x connecting the first main surface 12a and the second main surface 12b is preferably, for example, about 5 μm or more and about 55 μm or less.

Further, when base electrode layers (fired layers) are also provided on a portion of the first main surface 12a or a portion of the second main surface 12b, the thickness of each of the first fired layer and the second fired layer provided on the first main surface 12a or the second main surface 12b in the lamination direction x connecting the first main surface 12a and the second main surface 12b at a middle portion in the first direction y connecting the first surface 12c and the second surface 12d is preferably, for example, about 1 μm or more and about 30 μm or less.

Next, a case where the base electrode layer 32 is provided as an electrically conductive resin layer will be described. The electrically conductive resin layer may be provided on the fired layer to cover the fired layer, or may be provided directly on the multilayer body 12 without providing the fired layer. Further, the electrically conductive resin layer may completely cover the fired layer or may partially cover the fired layer. Further, the electrically conductive resin layer may include a plurality of layers.

The electrically conductive resin layer includes a thermosetting resin and a metal. Since the electrically conductive resin layer includes a thermosetting resin, the electrically conductive resin layer is more flexible than a fired layer made of, for example, a plated film or a fired product of an electrically conductive paste. For this reason, even when a physical impact or a shock due to thermal cycling is applied to the multilayer ceramic capacitor 10, the electrically conductive resin layer defines and functions as a buffer layer, so that cracks in the multilayer ceramic capacitor 10 can be prevented.

As the metal included in the electrically conductive resin layer, for example, Ag, Cu, Ni, Sn, Bi, or an alloy including them can be used. Alternatively, for example, a metal powder obtained by coating the surface of the metal powder with Ag may be used. When, for example, an Ag-coated metal powder is used, Cu, Ni, Sn, Bi or an alloy powder thereof is preferably used as the metal powder. The reason why the electrically conductive metal powder of Ag is used as the electrically conductive metal is that Ag is suitable for an electrode material because Ag has the lowest specific resistance among metals, Ag is a noble metal, and thus does not oxidize and has high weather resistance. The reason why the Ag-coated metal is used is that the metal of the base material can be made inexpensively, while maintaining the above-described characteristics of Ag.

Further, as the metal included in the electrically conductive resin layer, for example, Cu and Ni subjected to antioxidation treatment may be used. As the metal included in the electrically conductive resin layer, for example, a metal powder obtained by coating the surface of the metal powder with Sn, Ni, or Cu may be used. When a metal powder coated with Sn, Ni, or Cu on the surface of the metal powder is used, for example, Ag, Cu, Ni, Sn, Bi or an alloy powder thereof is preferably used as the metal powder.

The metal included in the electrically conductive resin layer mainly provides electrical conductivity to the electrically conductive resin layer. Specifically, electrically conductive fillers contact each other to provide an electric conduction path inside the electrically conductive resin layer.

As the metal included in the electrically conductive resin layer, for example, a metal having a spherical shape, a metal having a flat shape, or the like can be used, and it is preferable to use a mixture of a spherical metal powder and a flat metal powder.

As the resin of the electrically conductive resin layer, for example, various known thermosetting resins such as an epoxy resin, a phenol resin, a urethane resin, a silicone resin, or a polyimide resin can be used. Among them, an epoxy resin excellent in heat resistance, moisture resistance, adhesion, and the like is one of the preferable resins.

The electrically conductive resin layer preferably includes a curing agent together with the thermosetting resin. As the curing agent, for example, when an epoxy resin is used as the base resin, various known compounds such as phenol-based, amine-based, acid anhydride-based, imidazole-based, active ester-based, or amide imide-based compounds can be used as curing agents for the epoxy resin.

The thickest portion of the electrically conductive resin layer is preferably, for example, about 5 μm or more and about 50 μm or less.

Next, a case where the base electrode layer 32 is provided as a thin film layer will be described. The thin film layer may be provided on the surface of the multilayer body 12. When a thin film layer is provided as the base electrode layer 32, the thin film layer is formed by a thin film formation method such as, for example, a sputtering method or a vapor deposition method. The thin film layer is a layer of, for example, about 1 μm or less in which metal particles are deposited.

Further, the base electrode layer 32 may be provided as a plated layer. In this case, the plated layer preferably includes at least one metal of, for example, Cu, Ni, Sn, Pd, Au, Ag, Bi, Zn, or the like, or an alloy including such a metal as a plating component. The plated layer preferably does not include glass, and the metal ratio per unit area of the plated layer is preferably, for example, about 99% by volume or more.

The lower plated layer 34 includes a first lower plated layer 34a provided to cover the first base electrode layer 32a, a second lower plated layer 34b provided to cover the second base electrode layer 32b, a third lower plated layer 34c provided to cover the third base electrode layer 32c, and a fourth lower plated layer 34d provided to cover the fourth base electrode layer 32d.

The lower plated layer 34 includes, for example, at least one selected from Cu, Ni, Sn, Ag, Pd, an Ag—Pd alloy, Au, or the like.

The lower plated layer 34 is preferably, for example, a Ni plated layer. When the lower plated layer 34 is a Ni plated layer, it is possible to prevent the base electrode layer 32 from being eroded by solder when mounting the multilayer ceramic capacitor 10.

The thickness of the lower plated layer 34 is preferably, for example, about 1 μm or more and about 8 μm or less.

The upper plated layer 36 includes a first upper plated layer 36a provided to cover the first lower plated layer 34a, a second upper plated layer 36b provided to cover the second lower plated layer 34b, a third upper plated layer 36c provided to cover the third lower plated layer 34c, and a fourth upper plated layer 36d provided to cover the fourth lower plated layer 34d.

The upper plated layer 36 includes, for example, at least one of Cu, Ni, Sn, Ag, Pd, an Ag—Pd alloy, Au, or the like.

The upper plated layer 36 is preferably, for example, Sn plating. When the upper plated layer 36 is Sn plating, it is possible to improve the wettability of solder when mounting the multilayer ceramic capacitor 10, and it is possible to mount it easily.

The thickness of the upper plated layer 36 is preferably, for example, about 1 μm or more and about 8 μm or less.

The plated layer includes a two-layer configuration of the lower plated layer 34 and the upper plated layer 36, but is not limited thereto, and may include, for example, a three-layer configuration. When the plated layer includes a three-layer configuration, it is preferable that the plated layer includes Sn plating, Ni plating, and Sn plating in this order from the multilayer body 12 side.

The dimension of the multilayer ceramic capacitor 10 including the multilayer body 12 and the external electrodes 30 in the first direction y is defined as an L dimension. The L dimension is preferably, for example, about 0.51 mm or more and about 3.2 mm or less. The dimension of the multilayer ceramic capacitor 10 including the multilayer body 12 and the external electrodes 30 in the second direction z is defined as a W dimension. The W dimension is preferably, for example, about 0.21 mm or more and about 2.5 mm or less. The dimension of the multilayer ceramic capacitor 10 including the multilayer body 12 and the external electrodes 30 in the lamination direction x is defined as a T dimension. The T dimension is preferably, for example, about 0.05 mm or more and about 2.5 mm or less.

Next, the joining electrode 40 will be described. On either one of the first main surface 12a or the second main surface 12b of the multilayer body 12, a joining electrode 40 that electrically joins at least two or more external electrodes 30 of the same potential among the external electrodes 30 is provided.

In the multilayer ceramic electronic component 100 according to the first example embodiment, the joining electrode 40 electrically joins the first external electrode 30a and the second external electrode 30b of the multilayer ceramic capacitor 10 on the first main surface 12a of the multilayer body 12.

The joining electrode 40 includes a joining base electrode 42, a joining lower plated layer 44 covering the joining base electrode 42, and a joining upper plated layer 46 covering the joining lower plated layer 44. The joining electrode 40 may include only the joining base electrode 42. In this case, the joining base electrode 42 is formed, for example, by a sputtered electrode.

When the direct current resistance of the multilayer ceramic capacitor 10 is defined as Rdc1 and the direct current resistance of the joining electrode 40 is defined as Rdc3, it is preferable that, for example, Rdc1≤Rdc3 is satisfied. When Rdc1>Rdc3 is satisfied, electrical current including noise components becomes difficult to flow through the capacitor due to the effect of voltage division, such that the noise removal effect becomes small.

Rdc3 is preferably, for example, about 1.0 times or more and about 5.0 times or less of Rdc1. Basically, if the combined resistance is reduced, current will flow more easily. However, when Rdc 3 is greater than about 5.0 times Rdc1, the effect of making current flow more easily decreases.

The thickness t1 of the joining electrode 40 in the lamination direction x is preferably thinner than the thickness t2 of the external electrode 30 provided on the same plane as the joining electrode 40 in the lamination direction x.

The joining electrode 40 can reduce Rdc3 as the thickness in the lamination direction x increases. However, when the thickness of the joining electrode 40 becomes greater than the dimension of the external electrode 30 provided on the main surface in the lamination direction x, the dimension of the entire multilayer ceramic capacitor 10 in the lamination direction x becomes large. Therefore, by making the thickness of the joining electrode 40 in the lamination direction x thinner than the thickness of the external electrode 30 provided on the same plane as the joining electrode 40 in the lamination direction, it is possible to increase Rdc3, and it is possible to allow a large current to flow through the multilayer ceramic capacitor 10 without making the dimension of the multilayer ceramic capacitor 10 in the lamination direction x excessively large.

The method of measuring the Rdc of each of the joining electrode 40 and the multilayer ceramic capacitor 10 is as follows, for example. That is, first, the external electrode 30 of the multilayer ceramic capacitor 10 connected to the joining electrode 40 is removed from the surface of the multilayer body 12 by, for example, laser, polishing, or solvent treatment. At this time, either one of the external electrodes 30 connected to the joining electrode 40 is required to be removed from the surface of the multilayer body 12. Thereafter, each of the joining electrode 40 and the multilayer ceramic capacitor 10 is measured using a four-terminal method.

The main component of the joining electrode 40 is preferably a metal such as, for example, Cu, NiCr, or NiCu, but is not limited thereto.

The porosity of the joining base electrode 42 of the joining electrode 40 is preferably greater than the porosity of the base electrode layer 32 of the external electrode 30. By making the porosity of the joining base electrode 42 greater than the porosity of the base electrode layer 32, it is possible to increase Rdc3. When the joining lower plated layer 44 and the joining upper plated layer 46 are provided, the porosity is defined by the area when voids and other portions are binarized when the joining base electrode 42 and the base electrode layer 32 are viewed in the lamination direction x after the joining lower plated layer 44 and the joining upper plated layer 46 are removed.

If the T dimension becomes about 100 μm or less, for example, about 50 μm or less, the deflection strength becomes low. For this reason, by providing the joining electrode 40 on either the first main surface 12a or the second main surface 12b of the multilayer body 12, it is possible to improve the deflection strength of the multilayer ceramic capacitor 10.

The joining electrode 40 shown in FIG. 1 has a rectangular or substantially rectangular shape. However, the present invention is not limited thereto, and the length in the width direction of the middle region in the first direction y may be smaller or larger than the length in the width direction of the end portions. The joining electrode 40 may have a tapered shape in which the dimension in the second direction z becomes narrower from one end side to the other end side, or from the other end to one end side, or may become narrower in a stepped shape.

According to the multilayer ceramic capacitor 10 shown in FIG. 1, the joining electrode 40 that electrically joins the first external electrode 30a and the second external electrode 30b is provided on the first main surface 12a. Since Rdc1≤Rdc3 is satisfied when the direct current resistance of the multilayer ceramic capacitor is defined as Rdc1 and the direct current resistance of the joining electrode 40 is defined as Rdc3, the combined resistance of the multilayer ceramic capacitor 10 and the joining electrode 40 becomes smaller than the resistance of the multilayer ceramic capacitor 10 alone, such that it is possible to provide the multilayer ceramic capacitor 10 that can handle larger currents.

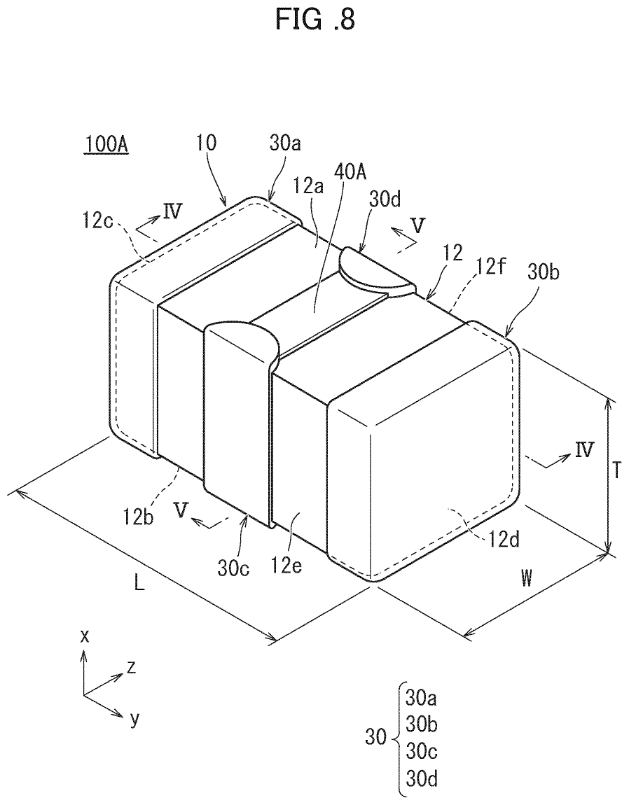

Next, an example of a multilayer ceramic electronic component 100A according to a first modified example of the first example embodiment of the present invention will be described. FIG. 8 is an external perspective view of a multilayer ceramic electronic component according to a modified example of the first example embodiment of the present invention. However, the same or corresponding configurations as those in FIGS. 1 to 7 are assigned the same reference numerals, and detailed descriptions thereof are omitted.

The multilayer ceramic electronic component 100A according to the first modified example includes the multilayer ceramic capacitor 10 and a joining electrode 40A, as shown in FIG. 8.

In the first example embodiment, in the multilayer ceramic electronic component 100A, the joining electrode 40A electrically joins the third external electrode 30c and the fourth external electrode 30d of the multilayer ceramic capacitor 10 on the first main surface 12a of the multilayer body 12.

When the direct current resistance of the multilayer ceramic capacitor 10 is defined as Rdc1 and the direct current resistance of the joining electrode 40A is defined as Rdc3, it is preferred that Rdc1≤Rdc3 is satisfied.

Next, a mounting structure 300 of the multilayer ceramic electronic component 100 according to the present example embodiment of the present invention will be described.

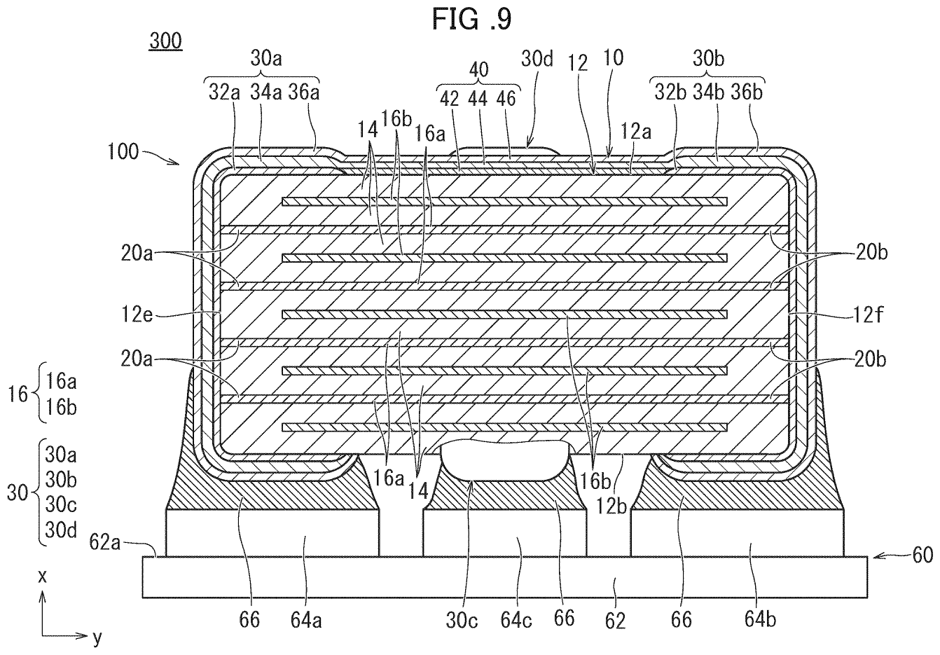

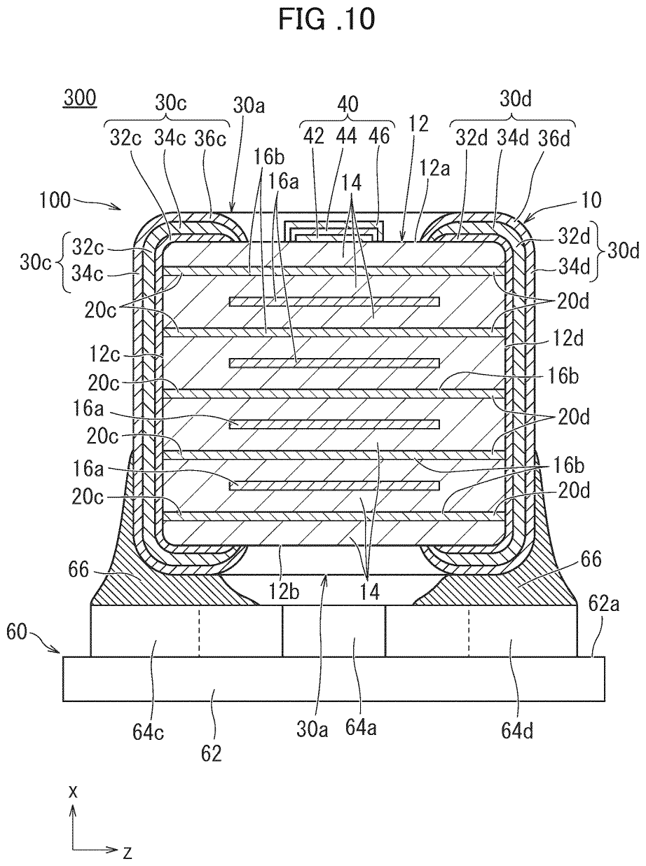

FIG. 9 is a cross-sectional view in the lamination direction showing a mounting structure of the multilayer ceramic electronic component according to the first example embodiment of the present invention. FIG. 10 is a cross-sectional view in the second direction showing a mounting structure of the multilayer ceramic electronic component according to the first example embodiment of the present invention.

The mounting structure 300 of the multilayer ceramic electronic component according to the present example embodiment includes the multilayer ceramic electronic component 100 according to the present example embodiment and the mounting substrate 60, as shown in FIGS. 9 and 10. The mounting substrate 60 includes a core material 62 of the substrate and connection conductors (conductor lands) 64.

The core material 62 of the substrate includes, for example, a substrate made of a material obtained by impregnating a base material obtained by mixing a glass cloth and a glass nonwoven fabric with an epoxy resin or a polyimide resin, or a ceramic substrate manufactured by firing a sheet obtained by mixing ceramics and glass. The core material 62 of the substrate may be a single-layer substrate or a substrate including a plurality of laminated layers. The thickness of the core material 62 of the substrate is not particularly limited, but is preferably about 200 μm or more and about 800 μm or less, for example.

One main surface of the core material 62 of the substrate is provided with the conductor lands 64 and defines a substrate-side mounting surface 62a defining and functioning as a mounting surface of the multilayer ceramic electronic component 100.

The conductor lands 64 include a first conductor land 64a, a second conductor land 64b, a third conductor land 64c, and a fourth conductor land 64d.

The first conductor land 64a is electrically connected to the first external electrode 30a of the multilayer ceramic capacitor 10 by a joining material 66, and is mechanically joined thereto. The second conductor land 64b is electrically connected to the second external electrode 30b of the multilayer ceramic capacitor 10 by the joining material 66, and is mechanically joined thereto. The third conductor land 64c is electrically connected to the third external electrode 30c of the multilayer ceramic capacitor 10 by the joining material 66, and is mechanically joined thereto. The fourth conductor land 64d is electrically connected to the fourth external electrode 30d of the multilayer ceramic capacitor 10 by the joining material 66, and is mechanically joined thereto.

The conductor lands 64 may be provided on the main surface of the core material 62 of the substrate opposite to the substrate-side mounting surface 62a.

Although the material of the conductor lands 64 is not particularly limited, for example, a metal such as Cu, Au, Pd, or Pt can be used. The thickness of each of the conductor lands 64, that is, the dimension in the lamination direction x, is not particularly limited, but is preferably, for example, about 20 μm or more and about 200 μm or less. As the joining material 66, for example, an epoxy-based adhesive for high heat resistance, or solder may be used.

In the above description, the mounting substrate 60 corresponds to the mounting substrate. The core material 62 of the substrate corresponds to the core material of the substrate. The substrate-side mounting surface 62a corresponds to the mounting surface. The plurality of conductor lands 64 corresponds to a plurality of connection conductors. However, the connection conductor of the present invention is not limited to a land and is not limited by other applications, functions, shapes, names, etc., as long as the connection conductor is a conductor that is provided between the multilayer ceramic capacitor 10 and the mounting substrate 60 and can electrically connect them to each other.

In the mounting structure 300 of the multilayer ceramic electronic component, the first external electrode 30a and the second external electrode 30b are connected to the anode. With such a configuration, the current distance becomes short, and it is possible to reduce or prevent an increase in insulation resistance while ensuring moisture resistance reliability.

In the mounting structure 300 of the multilayer ceramic electronic component shown in FIGS. 9 and 10, it is preferable that the multilayer ceramic electronic component 100 is mounted such that the joining electrode 40 of the multilayer ceramic electronic component 100 is provided in a direction opposite to the mounting substrate 60. That is, it is preferable that the joining electrode 40 of the multilayer ceramic electronic component 100 is provided adjacent to the first main surface (non-mounting surface side) of the multilayer ceramic capacitor 10, and the multilayer ceramic capacitor 10 of the multilayer ceramic electronic component 100 is mounted adjacent to the mounting substrate 60. By mounting in this way, the distance between the multilayer ceramic capacitor 10 and the mounting substrate 60 does not become large, such that it is easy to obtain the effect of low ESL. In addition, it is possible to mount without affecting the mounting of the multilayer ceramic electronic component 100 to the mounting substrate.

Hereinafter, an example of a method of manufacturing the multilayer ceramic capacitor 10 according to the present example embodiment will be described.

First, a dielectric sheet and an electrically conductive paste for manufacturing internal electrodes are prepared. The dielectric sheet and the electrically conductive paste for manufacturing internal electrodes include a binder and a solvent. Known binders and solvents can be used.

Next, the electrically conductive paste for manufacturing internal electrodes is printed in a predetermined pattern on the dielectric sheet by, for example, inkjet printing, screen printing, or gravure printing. With this method, a dielectric sheet on which a pattern of the first internal electrode is formed and a dielectric sheet on which a pattern of the second internal electrode is formed are prepared. Thereafter, by laminating the sheet on which the first internal electrode is printed and the sheet on which the second internal electrode is printed, a portion defining and functioning as the inner layer portion 18 is formed.

Next, by laminating a predetermined number of dielectric sheets on which the pattern of the internal electrode is not printed, a portion defining and functioning as the first outer layer portion 20a adjacent to the first main surface 12a is formed. Thereafter, the portion defining and functioning as the inner layer portion 18 prepared above is laminated, and a predetermined number of dielectric sheets on which the pattern of the internal electrode is not printed are laminated on the portion defining and functioning as the inner layer portion 18, such that a portion defining and functioning as the second outer layer portion 20b adjacent to the second main surface 12b is formed. A multilayer sheet is manufactured with such a method.

Next, the multilayer sheet is pressed in the lamination direction by, for example, isostatic pressing or the like to produce a multilayer block.

Subsequently, the multilayer block is cut into multilayer chips with a predetermined size. Each multilayer chip may be rounded at its corner portions and ridge portions by barrel polishing or the like.

Next, the multilayer chip is fired to manufacture the multilayer body 12. The firing temperature depends on the materials of the ceramic and the internal electrodes, but is preferably, for example, about 900° C. or more and about 1400° C. or less.

Next, the joining electrode 40 is formed on the surface of the first main surface 12a of the multilayer body 12. To form the joining electrode 40, the joining base electrode 42 is formed using, for example, a method in which an electrically conductive paste is applied by being extruded through slits or a screen printing method.

Then, the first base electrode layer 32a of the first external electrode 30a and the second base electrode layer 32b of the second external electrode 30b are formed on the first surface 12c and the second surface 12d of the multilayer body 12 on which the joining electrode 40 is formed. Further, the third base electrode layer 32c of the third external electrode 30c and the fourth base electrode layer 32d of the fourth external electrode 30d are formed on the third surface 12e and the fourth surface 12f of the multilayer body 12 obtained by firing.

In a case in which a fired layer is formed as the base electrode layer 32, an electrically conductive paste including a glass component and a metal component is applied, and then fired to form the base electrode layer 32.

More specifically, first, the third base electrode layer 32c of the third external electrode 30c and the fourth base electrode layer 32d of the fourth external electrode 30d are formed on the third surface 12e and the fourth surface 12f of the multilayer body 12 obtained by firing.

Here, as an example of a method of forming the third base electrode layer 32c and the fourth base electrode layer 32d, various methods can be used. For example, a method in which an electrically conductive paste is applied by being extruded through slits can be used. In the case of this method, by increasing the extrusion amount of the electrically conductive paste, the third base electrode layer 32c and the fourth base electrode layer 32d can be formed not only on the third surface 12e and the fourth surface 12f, but also on a portion of the first main surface 12a and a portion of the second main surface 12b.

Alternatively, for example, a roller transfer method can be used for formation. In the case of the roller transfer method, in a case in which the third base electrode layer 32c and the fourth base electrode layer 32d are formed not only on the third surface 12e and the fourth surface 12f, but also on a portion of the first main surface 12a and a portion of the second main surface 12b, the third base electrode layer 32c and the fourth base electrode layer 32d can be formed on a portion of the first main surface 12a and a portion of the second main surface 12b by increasing the pressing pressure during roller transfer.

Next, the first base electrode layer 32a of the first external electrode 30a and the second base electrode layer 32b of the second external electrode 30b are formed on the first surface 12c and the second surface 12d of the multilayer body 12 obtained by firing.

Here, as an example of a method of forming the first base electrode layer 32a and the second base electrode layer 32b, various methods can be used. For example, by using a method such as dipping, the first base electrode layer 32a and the second base electrode layer 32b can be formed to extend not only on the first surface 12c and the second surface 12d, but also on a portion of the first main surface 12a and a portion of the second main surface 12b, and on a portion of the third surface 12e and a portion of the fourth surface 12f.

In the present example embodiment, the first base electrode layer 32a and the second base electrode layer 32b, and the third base electrode layer 32c and the fourth base electrode layer 32d may be fired simultaneously.

In a case in which an electrically conductive resin layer is formed as the base electrode layer 32, the electrically conductive resin layer can be formed by the following method, for example. The electrically conductive resin layer may be formed on the surface of the fired layer, or the electrically conductive resin layer may be solely formed directly on the multilayer body without forming the fired layer.

As a method for forming the electrically conductive resin layer, an electrically conductive resin paste including a thermosetting resin and a metal component is applied to the fired layer or the multilayer body, and heat treatment is performed at a temperature of, for example, about 250° C. or more and about 550° C. or less to thermally cure the resin, thus forming the electrically conductive resin layer. The atmosphere during the heat treatment is preferably, for example, an N₂ atmosphere. Also, in order to prevent the scattering of the resin and prevent oxidation of various metal components, it is preferable to keep the oxygen concentration at, for example, about 100 ppm or less.

As a method of applying the electrically conductive resin paste, for example, a method of applying the electrically conductive resin paste by extruding the electrically conductive resin paste through a slit or a roller transfer method can be used in the same or substantially the same manner as the method of forming the base electrode layer 32 with the fired layer.

Thereafter, the lower plated layer 34 is formed on the base electrode layer 32 and on the surface of the multilayer body 12, and the upper plated layer 36 is formed to cover the lower plated layer 34. Simultaneously, the joining lower plated layer 44 is formed on the surface of the joining base electrode 42, and the joining upper plated layer 46 is formed to cover the joining lower plated layer 44. More specifically, for example, a Ni plated layer is formed as the lower plated layer 34 on the base electrode layer 32. Thereafter, for example, an Sn plated layer is formed as the upper plated layer 36 on the surface of the lower plated layer 34. Similarly, for example, a Ni plated layer is formed as the joining lower plated layer 44 on the joining base electrode 42, and an Sn plated layer is formed as the joining upper plated layer 46 on the surface of the joining lower plated layer 44. For performing the plating treatment, either electrolytic plating or electroless plating may be used. However, electroless plating requires pretreatment with a catalyst or the like in order to improve the plating deposition rate, which has the disadvantage of complicating the process. Therefore, it is normally preferable to employ electrolytic plating.

The multilayer ceramic electronic component 100 shown in FIG. 1 can be manufactured in the above manner.

Alternatively, the joining electrode 40 may be formed after manufacturing the fired multilayer body 12 and forming the external electrodes 30 on the multilayer body 12.

That is, after the external electrodes 30 are formed and the multilayer ceramic capacitor 10 is obtained, the joining electrode 40 is formed on the surface of the first main surface 12a of the multilayer body 12 of the multilayer ceramic capacitor 10 by, for example, screen printing or sputtering.

With such a configuration, the multilayer ceramic electronic component 100 shown in FIG. 1 can be manufactured.

Hereinafter, each modified example (first modified example and second modified example) of the multilayer ceramic capacitor in the multilayer ceramic electronic component according to the first example embodiment will be described. For these modified examples, components corresponding to those of the above example embodiment are denoted by the same reference numerals, and detailed descriptions thereof are omitted.

A multilayer ceramic capacitor 10A according to a first modified example of the present example embodiment is different from the multilayer ceramic capacitor 10 according to the present example embodiment only in the configuration of the multilayer body 12A of the multilayer ceramic capacitor 10A. Therefore, the same or corresponding components as those of the multilayer ceramic capacitor 10 are denoted by the same reference numerals, and descriptions thereof are omitted.

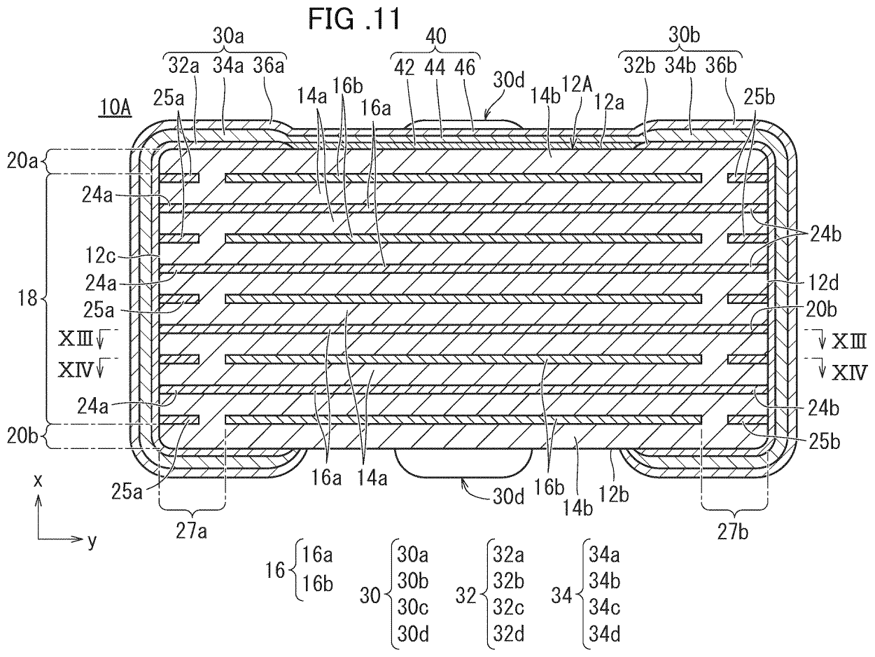

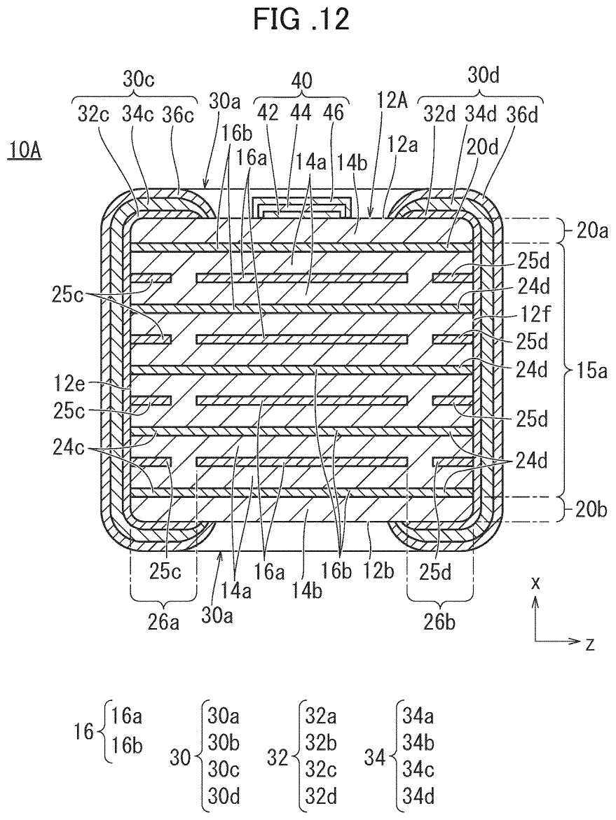

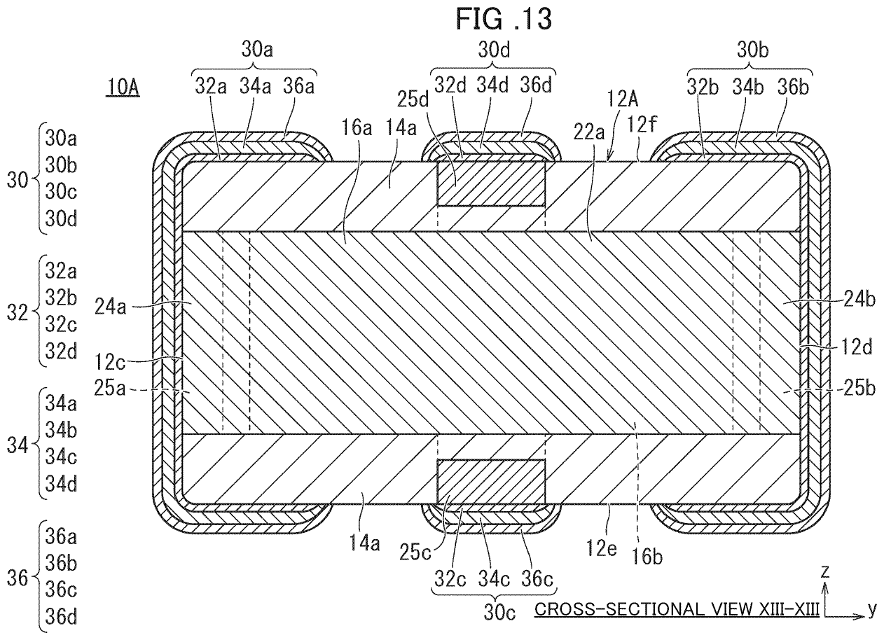

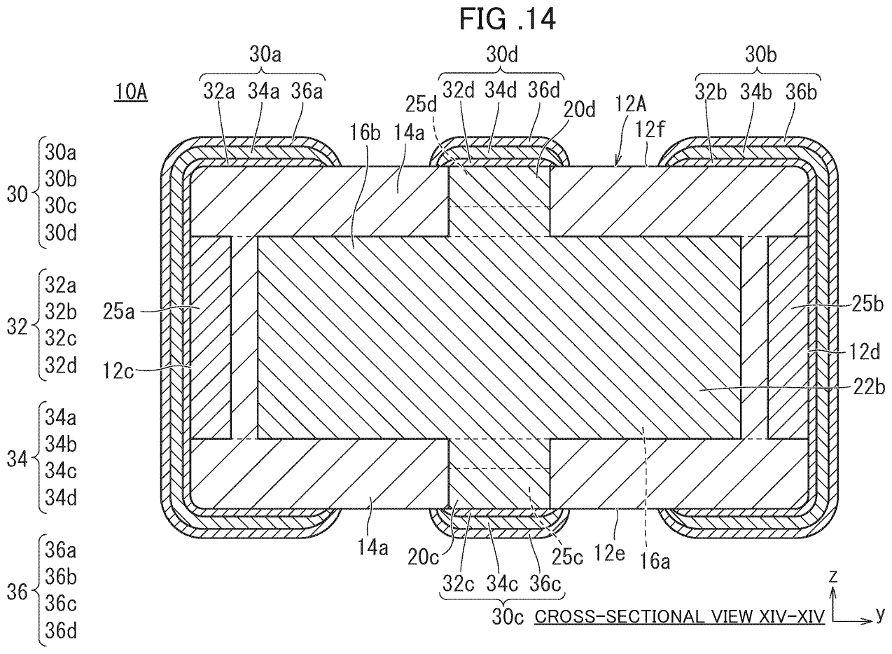

FIG. 11 is a cross-sectional view showing a first modified example of the multilayer ceramic capacitor according to the first example embodiment of the present invention, and is a view corresponding to the cross-sectional view of FIG. 4. FIG. 12 is a cross-sectional view showing a first modified example of the multilayer ceramic capacitor according to the first example embodiment of the present invention, and is a view corresponding to the cross-sectional view of FIG. 5. FIG. 13 is a cross-sectional view taken along the line XIII-XIII of FIG. 11. FIG. 14 is a cross-sectional view taken along the line XIV-XIV of FIG. 11.

The multilayer ceramic capacitor 10A includes a multilayer body 12A and external electrodes 30.

The multilayer body 12A includes a first main surface 12a and a second main surface 12b opposed to each other in the lamination direction x, a first surface 12c and a second surface 12d opposed to each other in the first direction y orthogonal or substantially orthogonal to the lamination direction x, and a third surface 12e and a fourth surface 12f opposed to each other in the second direction z orthogonal or substantially orthogonal to the lamination direction x and the first direction y.

The multilayer body 12A includes a plurality of dielectric layers 14 and a plurality of internal electrodes 16. The dielectric layers 14 include inner dielectric layers 14a and outer dielectric layers 14b. Further, the internal electrodes 16 include first internal electrodes 16a and second internal electrodes 16b.

In the end portion (L gap) 27a of the multilayer body 12A, first dummy electrodes 25a are exposed at the first surface 12c. In the end portion (L gap) 27b of the multilayer body 12A, second dummy electrodes 25b are exposed at the second surface 12d.

Each of the first dummy electrodes 25a and each of the second dummy electrodes 25b are preferably provided on the same plane as corresponding ones of the second internal electrodes 16b, and have the same or substantially the same thickness as the second internal electrodes 16b.

In a case in which the coverages of the first dummy electrodes 25a and the second dummy electrodes 25b are reduced, the electric current path can be shortened.

The first dummy electrodes 25a and the second dummy electrodes 25b may also be provided in the first outer layer portion 20a and the second outer layer portion 20b. In this case, it is preferable that the first dummy electrodes 25a and the second dummy electrodes 25b are provided in a portion corresponding to a position where the end portions (L gaps) 27a and 27b are moved in parallel or substantially in parallel in the lamination direction x. By providing this configuration, in a case in which the plated layer is provided without providing the base electrode layer 32, it is possible to form the plated layer easily.

Further, in a case in which the first dummy electrodes 25a and the second dummy electrodes 25b are provided on the same plane as the second internal electrodes 16b, the first dummy electrodes 25a and the second dummy electrodes 25b can be provided on the same plane as the second internal electrodes 16b by printing the first dummy electrodes 25a and the second dummy electrodes 25b together with the second internal electrodes 16b when the second internal electrodes 16b are printed.

In addition, in the side portion (W gap) 26a of the multilayer body 12A, the third dummy electrodes 25c may be exposed at the third surface 12e. In the side portion (W gap) 26b of the multilayer body 12A, the fourth dummy electrodes 25d may be exposed at the fourth surface 12f.

Each of the third dummy electrodes 25c and each of the fourth dummy electrodes 25d are preferably provided on the same plane as corresponding ones of the first internal electrodes 16a, and have the same or substantially the same thickness as the first internal electrodes 16a.

In a case in which the coverages of the third dummy electrodes 25c and the fourth dummy electrodes 25d are reduced, the electric current path can be shortened.

The third dummy electrodes 25c and the fourth dummy electrodes 25d may also be provided in the first outer layer portion 20a and the second outer layer portion 20b. In this case, it is preferable that the third dummy electrodes 25c and the fourth dummy electrodes 25d are provided in a portion corresponding to a position where the side portions (W gaps) 26a and 26b are moved in parallel or substantially parallel in the lamination direction x. With this configuration, in a case in which the plated layer is provided without providing the base electrode layer 32, it is possible to form the plated layer easily.

Further, in a case in which the third dummy electrodes 25c and the fourth dummy electrodes 25d are provided on the same plane as the first internal electrodes 16a, the third dummy electrodes 25c and the fourth dummy electrodes 25d can be provided on the same plane as the first internal electrodes 16a by printing the third dummy electrodes 25c and the fourth dummy electrodes 25d together with the second internal electrode 16b when the first internal electrode 16a is printed.

In the multilayer ceramic capacitor 10A shown in FIGS. 11 to 14, since the first dummy electrodes 25 a and the second dummy electrodes 25b are respectively provided in the end portions (L gaps) 27a and 27b of the multilayer body 12A, the third dummy electrodes 25c and the fourth dummy electrodes 25d are respectively provided in the side portions (W gaps) 26a and 26b of the multilayer body 12A, it is possible to reduce or prevent distortion during pressing.

The multilayer ceramic capacitor 10A shown in FIGS. 11 to 14 includes the first dummy electrodes 25a and the second dummy electrodes 25b respectively provided in the end portions (L gaps) 27a and 27b of the multilayer body 12A, and the third dummy electrodes 25c and the fourth dummy electrodes 25d respectively provided in the side portions (W gaps) 26a and 26b of the multilayer body 12A. However, the present invention is not limited thereto. That is, the first dummy electrodes 25a and the second dummy electrodes 25b may be provided in the end portions (L gaps) 27a and 27b of the multilayer body 12A, and the third dummy electrodes 25c and the fourth dummy electrodes 25d may not be provided in the side portions (W gaps) 26a and 26b of the multilayer body 12A. Alternatively, the third dummy electrodes 25c and the fourth dummy electrodes 25d may be provided in the side portions (W gaps) 26a and 26b of the multilayer body 12A, and the first dummy electrodes 25a and the second dummy electrodes 25b may not be provided in the end portions (L gaps) 27a and 27b of the multilayer body 12A.

A multilayer ceramic capacitor 10B according to a second modified example of the present example embodiment is different from the multilayer ceramic capacitor 10 according to the present example embodiment only in the configuration of the multilayer body 12B of the multilayer ceramic capacitor 10B. Therefore, the same or corresponding components as those of the multilayer ceramic capacitor 10 are denoted by the same reference numerals, and descriptions thereof are omitted.

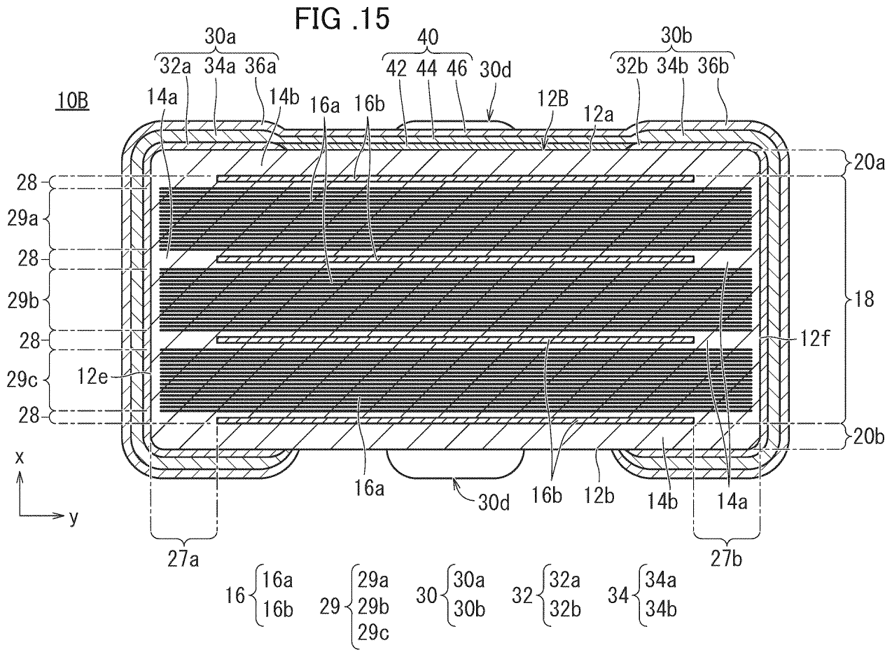

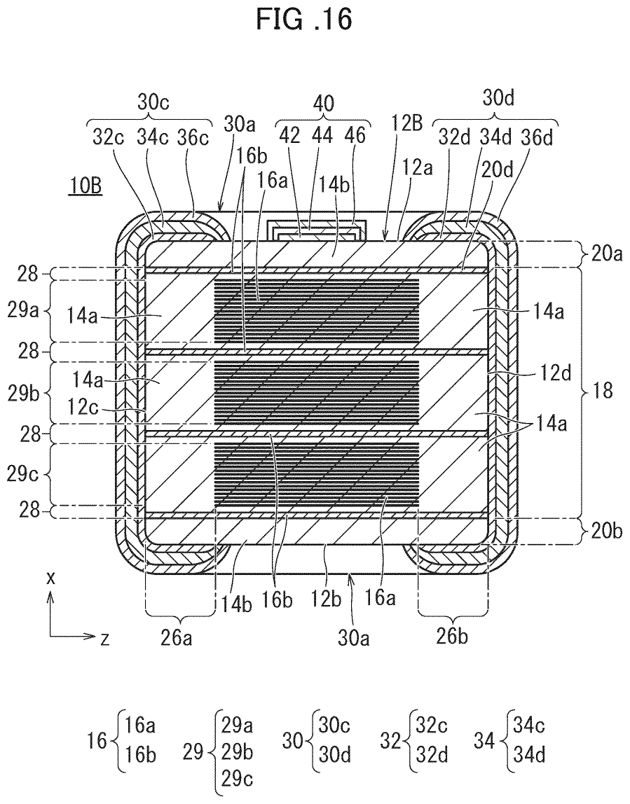

FIG. 15 is a cross-sectional view showing a second modified example of the multilayer ceramic capacitor according to the first example embodiment of the present invention, and corresponds to the cross-sectional view of FIG. 4. FIG. 16 is a cross-sectional view showing a second modified example of the multilayer ceramic capacitor according to the first example embodiment of the present invention, and corresponds to the cross-sectional view of FIG. 5.

The multilayer body 12B includes a first main surface 12a and a second main surface 12b opposed to each other in the lamination direction x, a first surface 12c and a second surface 12d opposed to each other in a first direction y orthogonal or substantially orthogonal to the lamination direction x, and a third surface 12e and a fourth surface 12f opposed to each other in a second direction z orthogonal or substantially orthogonal to the lamination direction x and the first direction y.

The multilayer body 12B includes a plurality of dielectric layers 14 and a plurality of internal electrodes 16. The dielectric layers 14 each include an inner dielectric layer 14a and an outer dielectric layer 14b. The internal electrodes 16 include first internal electrodes 16a and second internal electrodes 16b.

The multilayer body 12B includes an inner layer portion 18, and a first outer layer portion 20a and a second outer layer portion 20b that sandwich the inner layer portion 18 in the lamination direction x.

Each of the inner dielectric layers 14a of the inner layer portion 18 may be sandwiched between the first internal electrodes 16a. In this case, the respective first internal electrodes 16a are continuously provided via a corresponding one of the inner dielectric layers 14a in the inner layer portion 18 interposed therebetween.

Further, each of the inner dielectric layers 14a of the inner layer portion 18 may be sandwiched between the second internal electrodes 16b. In this case, the second internal electrodes 16b are continuously provided via a corresponding one of the dielectric layers 14 of the inner layer portion 18 interposed therebetween. Each of the inner dielectric layers 14a of the inner layer portion 18 is made of, for example, dielectric ceramic particles including a perovskite compound including Ba and Ti as a main component and having a perovskite structure. In addition, for example, at least one of Si, Mg, Ba, or Mn may be added as an additive to these main components. The additive is present between the ceramic particles.

The inner layer portion 18 of the multilayer body 12B includes capacitance generating portions 28 in which the first internal electrode 16a and the second internal electrode 16b are opposed to each other with a corresponding one of the dielectric layers 14 interposed therebetween to generate a capacitance, and internal electrode laminated portions 29 which are each a region in which two or more first internal electrodes 16a are continuously laminated. In the multilayer ceramic capacitor 10B, the capacitor characteristics are developed by the capacitance generating portion 28.

Further, the internal electrode laminated portions 29 are divided into a plurality of internal electrode laminated portions 29 by the second internal electrodes 16b. With such a configuration, since the aggregates of the first internal electrodes 16a are dispersed, the heat radiation effect is improved, and it is possible to achieve the advantageous effect of reducing or preventing the temperature rise.

As shown in FIGS. 15 and 16, in the multilayer ceramic capacitor 10B, the internal electrode laminated portions 29 are respectively divided by two second internal electrodes 16b into a first internal electrode laminated portion 29a, a second internal electrode laminated portion 296, and a third internal electrode laminated portion 29c.

The second internal electrodes 16b provided so as to divide the internal electrode laminated portion 29, which is a region in which two or more first internal electrodes 16a are continuously laminated, may be provided as a single electrode. With such a configuration, it is possible to laminate more first internal electrodes 16a, and it is possible to obtain the advantageous effect of reducing DC resistance.

In addition, regarding the second internal electrodes 16b provided so as to divide the internal electrode laminated portion 29, which is a region in which two or more first internal electrodes 16a are continuously laminated, two or more of the second internal electrodes 16b may be continuously laminated and provided. With such a configuration, even when the number of the second internal electrodes 16b is reduced, the connectivity between the second internal electrodes 16b and the external electrode 30 can be improved.

The second internal electrodes 16b may be respectively provided between the internal electrode laminated portion 29, which is a region where two or more first internal electrodes 16a located adjacent to the first main surface 12a of the multilayer body 12B are continuously laminated, that is, the first internal electrode laminated portion 29a and the first main surface 12a, and between the third internal electrode laminated portion 29, which is a region where two or more first internal electrodes 16a located adjacent to the second main surface 12b of the multilayer body 12B are continuously laminated, that is, the third internal electrode laminated portion 29c and the second main surface 12b. With such a configuration, since the capacitance generating portion 28 can be provided also in the vicinity of the first outer layer portion 20a and in the vicinity of the second outer layer portion 20b, a portion of the capacitance can be obtained, and the current path to the mounting substrate can be shortened, such that it is possible to achieve the advantageous effect of low ESL.

The second internal electrodes 16b may not necessarily be respectively provided between the internal electrode laminated portion 29, which is a region where two or more first internal electrodes 16a located adjacent to the first main surface 12a of the multilayer body 12B are continuously laminated, that is, the first internal electrode laminated portion 29a and the first main surface 12a, and between the third internal electrode laminated portion 29, which is a region where two or more first internal electrodes 16a located adjacent to the second main surface 12b of the multilayer body 12B are continuously laminated, that is, the third internal electrode laminated portion 29c and the second main surface 12b. With such a configuration, the distance from the surface of the multilayer body 12B to the capacitance generating portion 28 where the capacitance is generated is increased, and even if a crack is generated from the surface of the multilayer body 12B due to an external load, it is possible to obtain an advantageous effect in that insulation resistance degradation is less likely to occur.

The thickness of each of the inner dielectric layers 14a neighboring the second internal electrode 16b is preferably greater than the thickness of each of the inner dielectric layers 14a sandwiched between the first internal electrodes 16a. With such a configuration, it is possible to laminate more first internal electrodes 16a, and it is possible to further increase the advantageous effect of reducing the DC resistance.

The thickness of each of the second internal electrodes 16b is preferably greater than the thickness of each of the first internal electrodes 16a. With such a configuration, even when the capacitance is further reduced, it is possible to ensure the connectivity between the third extension electrode portion 24c of the second internal electrode 16b and the third external electrode 30c provided on the first surface 12c, and it is possible to ensure the connectivity between the fourth extension electrode portion 24d of the second internal electrode 16b and the fourth external electrode 30d provided on the second surface 12d.

Next, an example of a multilayer ceramic electronic component 500 according to a second example embodiment of the present invention will be described.

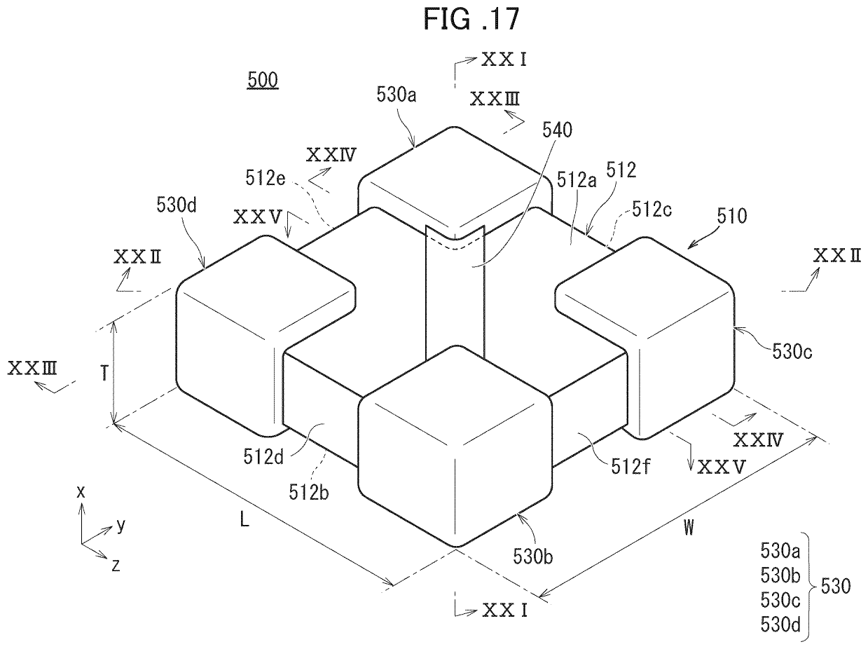

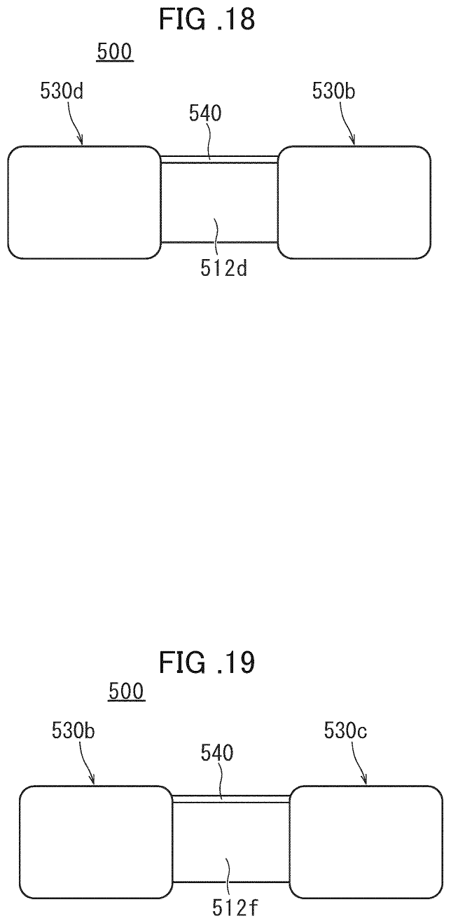

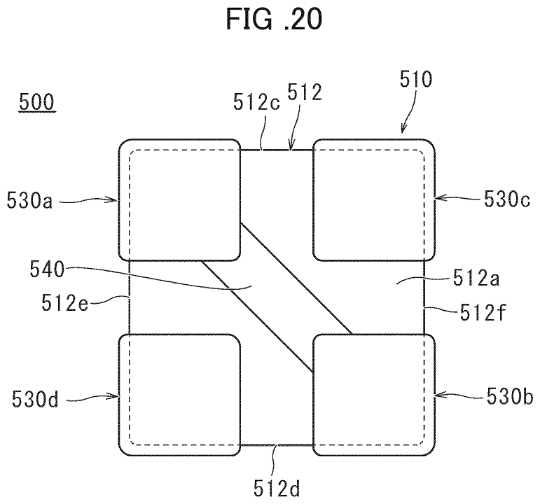

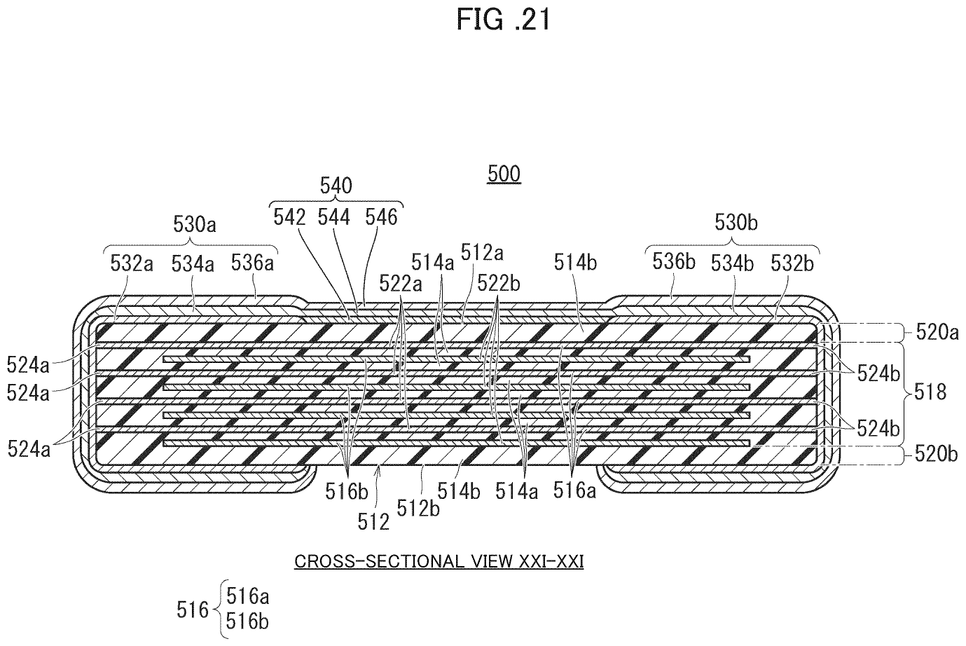

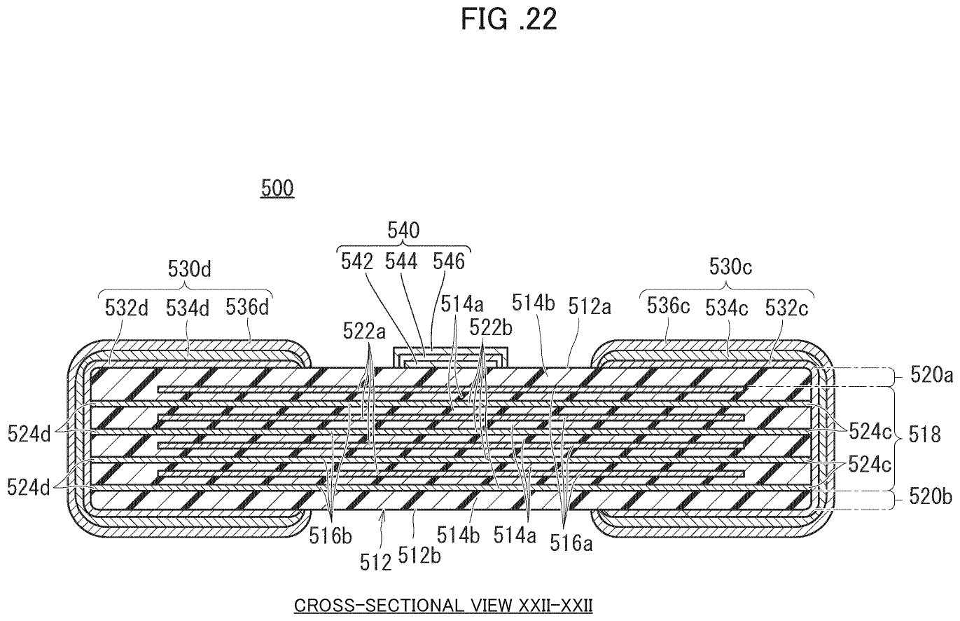

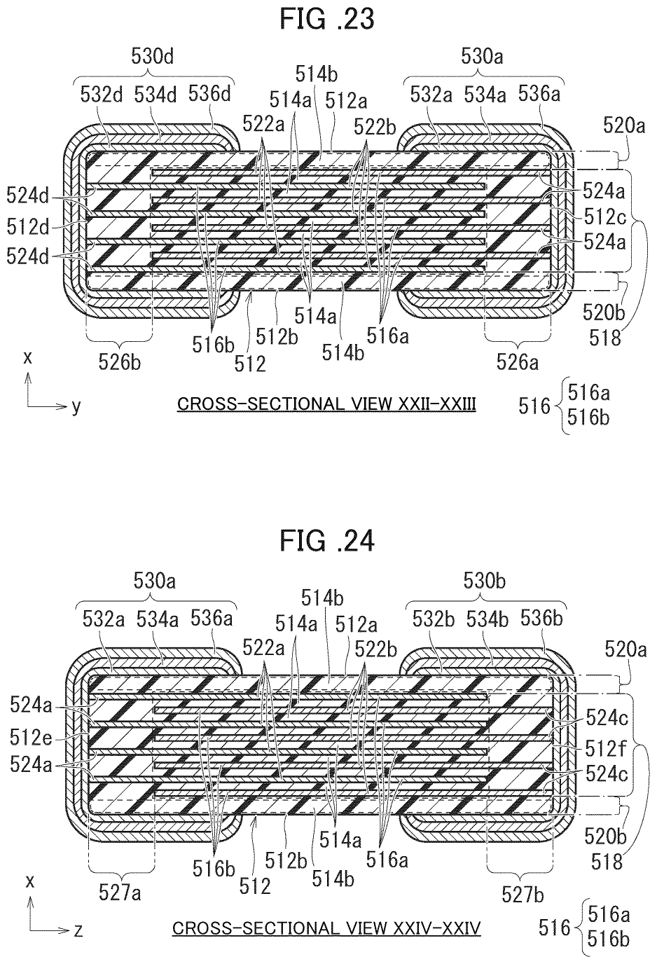

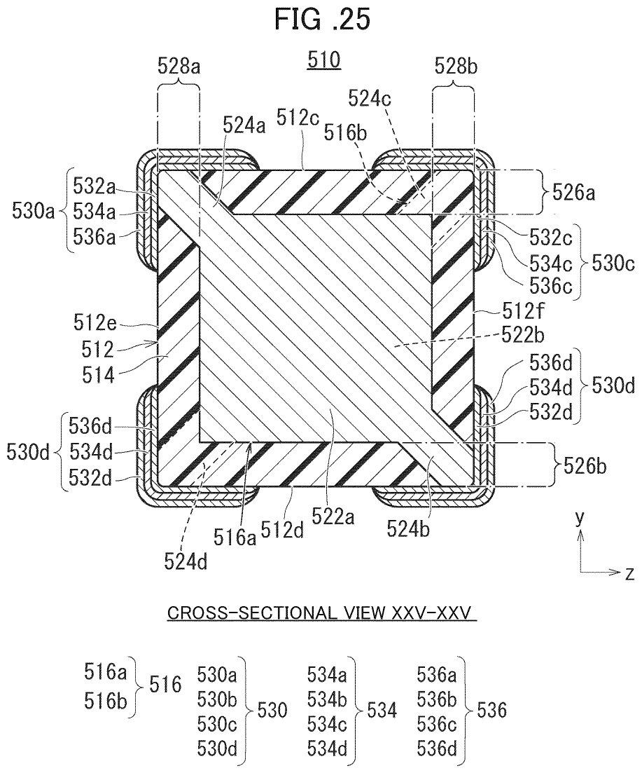

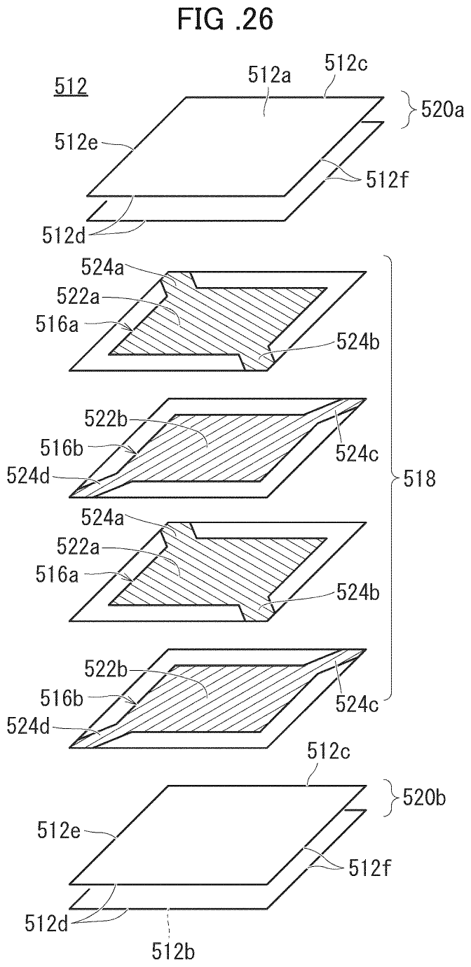

FIG. 17 is an external perspective view showing a multilayer ceramic electronic component according to a second example embodiment of the present invention. FIG. 18 is a front view of a multilayer ceramic electronic component according to the second example embodiment of the present invention. FIG. 19 is a side view of a multilayer ceramic electronic component according to the second example embodiment of the present invention. FIG. 20 is a plan view of a multilayer ceramic electronic component according to the second example embodiment of the present invention. FIG. 21 is a cross-sectional view taken along the line XXI-XXI of FIG. 17. FIG. 22 is a cross-sectional view taken along the line XXII-XXII of FIG. 17. FIG. 23 is a cross-sectional view taken along the line XXI-XXI of FIG. 17. FIG. 24 is a cross-sectional view taken along the line XXIV-XXIV of FIG. 17. FIG. 25 is a cross-sectional view taken along the line XXV-XXV of FIG. 17. FIG. 26 is an exploded perspective view of the multilayer body shown in FIG. 17.

The multilayer ceramic electronic component 500 includes a multilayer ceramic capacitor 510 and a joining electrode 540.

The multilayer ceramic capacitor 510 includes a multilayer body 512 and a plurality of external electrodes 530.

The multilayer body 512 includes a first main surface 512a and a second main surface 512b opposed to each other in the lamination direction x, a first surface 512c and a second surface 512d opposed to each other in a first direction y orthogonal or substantially orthogonal to the lamination direction x, and a third surface 512e and a fourth surface 512f opposed to each other in a second direction z orthogonal or substantially orthogonal to the lamination direction x and the first direction y. A direction connecting the first main surface 512a and the second main surface 512b of the multilayer body 512 corresponds to the lamination direction x.

The multilayer body 512 preferably has rounded corners and ridges. The corner portion is a portion where three adjacent surfaces of the multilayer body 512 intersect with each other, and the ridge line portion is a portion where two adjacent surfaces of the multilayer body 512 intersect with each other. The first main surface 512a and the second main surface 512b, the first surface 512c and the second surface 512d, and the third surface 512e and the fourth surface 512f may be partially or entirely uneven.

The multilayer body 512 includes a plurality of dielectric layers 514 and a plurality of internal electrodes 516. The dielectric layers 514 include inner dielectric layers 514a and outer dielectric layers 514b. The internal electrodes 516 include first internal electrodes 516a and second internal electrodes 516b.

The multilayer body 512 includes an inner layer portion 518, a first outer layer portion 520a located adjacent to the first main surface 512a, and a second outer layer portion 520b located adjacent to the second main surface 512b.

The first outer layer portion 520a is an aggregate of a plurality of outer dielectric layers 514b located adjacent to the first main surface 512a of the multilayer body 512 and located between the first main surface 512a and the internal electrode 516 closest to the first main surface 512a.

The second outer layer portion 520b is an aggregate of a plurality of outer dielectric layers 514b located adjacent to the second main surface 512b of the multilayer body 512 and located between the second main surface 512b and the internal electrode 516 closest to the second main surface 512b.

A region sandwiched between the first outer layer portion 520a and the second outer layer portion 520b corresponds to the inner layer portion 518.

The inner layer portion 518 includes first internal electrodes 516a each including one end exposed to the first surface 512c and the third surface 512e and the other end exposed to the second surface 512d and the fourth surface 512f, second internal electrodes 516b each having one end exposed to the first surface 512c and the third surface 512e and the other end exposed to the second surface 512d and the third surface 512e, and inner dielectric layers 514a.

Each of the dielectric layers 514 can be made of, for example, a dielectric material. As the dielectric material, for example, a dielectric ceramic including a main component such as BaTiO₃, CaTiO₃, SrTiO₃, or CaZrO₃ can be used. In addition, a material obtained by adding an auxiliary component such as, for example, a Mn compound, a Fe compound, a Cr compound, a Co compound, or a Ni compound to these main components may be used. The inner dielectric layers 514a and the outer dielectric layers 514b may be made of the same dielectric material or different dielectric materials.

For example, when the inner dielectric layers 514a each include, for example, a large amount of CaTiO₃ or CaZrO₃ as a dielectric component, it can be made unlikely for dielectric breakdown occurring between the first internal electrode 516a and the second internal electrode 516b to occur. Each of the inner dielectric layers 514a may include, for example, SrTiO₃ or the like as a main component. In addition, in order to increase the capacitance of the multilayer ceramic capacitor 10, it is preferable to use a material having a high dielectric constant, for example, BaTiO₃.

Each of the dielectric layers 514 may include a plurality of crystal grains including, for example, a perovskite compound having BaTiO₃ as a basic structure.

Since the capacity of a capacitor becomes larger as the dielectric layer 514 becomes thinner, the crystal grain size is preferably, for example, about 1 μm or less.

The number of dielectric layers 514 laminated is not particularly limited, but is preferably, for example, 5 or more and 1000 or less including the first outer layer portion 520a and the second outer layer portion 520b. The thickness of each of the dielectric layers 514 is preferably, for example, about 0.3 μm or more and about 6.0 μm or less.

The internal electrodes 516 include a plurality of first internal electrodes 516a and a plurality of second internal electrodes 516b. The first internal electrodes 516a and the second internal electrodes 516b are alternately laminated with a corresponding one of the dielectric layers 514 interposed therebetween.

Each of the first internal electrodes 516a is provided on a surface of a corresponding one of the inner dielectric layers 514a. Each of the first internal electrodes 516a includes a first counter electrode portion 522a that is opposed to the first main surface 512a and the second main surface 512b and is opposed to the second internal electrodes 516b, and is laminated in a direction connecting the first main surface 512a and the second main surface 512b.

Each of the first internal electrodes 516a extends toward the first surface 512c and the third surface 512e of the multilayer body 512 by the first extension electrode portion 524a, and extends toward the second surface 512d and the fourth surface 512f of the multilayer body 512 by the second extension electrode portion 524b. The width of the first extension electrode portion 524a extending toward and exposed on the first surface 512c may be equal or substantially equal to the width extending toward and exposed on the third surface 512e, and the width of the second extension electrode portion 524b extending toward and exposed on the second surface 512d may be equal or substantially equal to the width extending toward and exposed on the fourth surface 512f.

The first internal electrode 516a extends toward and is continuously exposed on the first surface 512c and the third surface 512e of the multilayer body 512 by the first extension electrode portion 524a, and also extends toward and is continuously exposed on the second surface 512d and the fourth surface 512f of the multilayer body 512 by the second extension electrode portion 524b. However, the present invention is not limited thereto, and the first internal electrode 516a may extend toward and be exposed on these surfaces discontinuously. Further, the first internal electrode 516a may be provided to be exposed on only one among the first surface 512c to the fourth surface 512f.

Each of the second internal electrodes 516b is provided on a surface of the inner dielectric layer 514a different from the inner dielectric layer 514a on which each of the first internal electrodes 516a is provided. Each of the second internal electrodes 516b includes a second counter electrode portion 522b that is opposed to the first main surface 512a and the second main surface 512b and is opposed to the first internal electrodes 516a, and is laminated in a direction connecting the first main surface 512a and the second main surface 512b.

Each of the second internal electrodes 516b extends toward the first surface 512c and the fourth surface 512f of the multilayer body 512 by the third extension electrode portion 524c, and extends toward the second surface 512d and the third surface 512e of the multilayer body 512 by the fourth extension electrode portion 524d. The width of the third extension electrode portion 524c extending toward and exposed on the first surface 512c may be equal or substantially equal to the width extending toward and exposed on the fourth surface 512f, and the width of the fourth extension electrode portion 524d extending toward and exposed on the second surface 512d may be equal or substantially equal to the width extending toward and exposed on the third surface 512e.

The second internal electrode 516b extends toward and is continuously exposed on the first surface 512c and the fourth surface 512f of the multilayer body 512 by the third extension electrode portion 524c, and also extends toward and is continuously exposed on the second surface 512d and the third surface 512e of the multilayer body 512 by the fourth extension electrode portion 524d. However, the present invention is not limited thereto, and the second internal electrode 516b may extend toward and be exposed on these surfaces discontinuously. Further, the second internal electrode 516b may be exposed on only one among the first surface 512c to the fourth surface 512f.

When the multilayer ceramic capacitor 510 is viewed from the lamination direction, it is preferable that a straight line connecting the first extension electrode portion 524a and the second extension electrode portion 524b of the first internal electrode 516a and a straight line connecting the third extension electrode portion 524c and the fourth extension electrode portion 524d of the second internal electrode 516b intersect with each other.

As shown in FIG. 23, the multilayer body 512 includes a side portion (W gap) 526a of the multilayer body 512 located between one end of the second counter electrode portion 522b of the second internal electrode 516b in the first direction y and the first surface 512c, and a side portion (W gap) 526b of the multilayer body 512 located between the other end of the first counter electrode portion 522a of the first internal electrode 516a in the first direction y and the second surface 512d.

As shown in FIG. 24, the multilayer body 512 further includes an end portion (L gap) 527a of the multilayer body 512 located between one end of the second counter electrode portion 522b of the second internal electrode 516b in the second direction z and the third surface 512e, and a side portion (L gap) 527b of the multilayer body 512 located between the other end of the first counter electrode portion 522a of the first internal electrode 516a in the second direction z and the fourth surface 512f.

The first internal electrode 516a and the second internal electrode 516b may each include an appropriate electrically conductive material, such as a metal such as, for example, Ni, Cu, Ag, Pd, or Au or an alloy including at least one of them, such as a Ni—Cu alloy or a Ag—Pd alloy. However, the present invention is not limited thereto. Further, the first internal electrode 516a and the second internal electrode 516b may include the same electrically conductive material or may include different electrically conductive materials.

Further, by including, for example, Sn in the first internal electrode 516a and the second internal electrode 516b, the potential barrier height at the interface between the internal electrode 516 and the dielectric layer 514 is increased, and electric field concentration at the interface between the internal electrode 516 and the dielectric layer 514 can be reduced, such that high-temperature load reliability is improved. At this time, Sn can sufficiently provide its advantageous effect even when included in either one of the first internal electrode 516a or the second internal electrode 516b.

The total number of the first internal electrodes 516a and the second internal electrodes 516b is preferably, for example, 2 or more and 1000 or less. The thicknesses of each of the first internal electrodes 516a and each of the second internal electrodes 516b are not particularly limited, but are preferably about 0.3 μm or more and about 6.0 μm or less, for example.

In the present example embodiment, the first counter electrode portions 522a of the first internal electrodes 516a and the second counter electrode portions 522b of the second internal electrodes 516b are opposed to each other with a corresponding one of the inner dielectric layers 514a interposed therebetween, such that capacitance is generated and the characteristics of the capacitor are developed.

The external electrodes 530 include a plurality of external electrodes 530 connected to the first internal electrodes 516a and the second internal electrodes 516b. The external electrodes 530 include a first external electrode 530a, a second external electrode 530b, a third external electrode 530c, and a fourth external electrode 530d.

The first external electrode 530a is provided so as to cover the first extension electrode portions 524a on the first surface 512c and the third surface 512e, and is provided so as to cover a portion of the first main surface 512a and a portion of the second main surface 512b. The first external electrode 530a is electrically connected to the first extension electrode portions 524a of the first internal electrodes 516a.

The second external electrode 530b is provided so as to cover the second extension electrode portions 524b on the second surface 512d and the fourth surface 512f, and is provided so as to cover a portion of the first main surface 512a and a portion of the second main surface 512b. The second external electrode 530b is electrically connected to the second extension electrode portions 524b of the first internal electrodes 516a.

The third external electrode 530c is provided so as to cover the third extension electrode portions 524c on the first surface 512c and the fourth surface 512f, and is provided so as to cover a portion of the first main surface 512a and a portion of the second main surface 512b. The third external electrode 530c is electrically connected to the third extension electrode portions 524c of the second internal electrodes 516b.

The fourth external electrode 530d is provided so as to cover the fourth extension electrode portions 524d on the second surface 512d and the third surface 512e, and is provided so as to cover a portion of the first main surface 512a and a portion of the second main surface 512b. The fourth external electrode 530d is electrically connected to the fourth extension electrode portions 524d of the second internal electrodes 516b.

Although not illustrated, the first external electrode 530a to the fourth external electrode 530d are provided on the first main surface 512a or the second main surface 512b, but may not necessarily be provided on either one of the main surfaces. In this case, the dimension of the multilayer ceramic capacitor 510 in the lamination direction x can be reduced, such that it is possible to make the multilayer ceramic capacitor 510 thinner.

In the multilayer body 512, capacitance is generated by the first counter electrode portions 522a of the first internal electrodes 516a and the second counter electrode portions 522b of the second internal electrodes 516b being opposed to each other with the dielectric layers 514 interposed therebetween. Therefore, capacitance can be obtained between the first external electrode 530a and the second external electrode 530b connected to the first internal electrodes 516a, and the third external electrode 530c and the fourth external electrode 530d connected to the second internal electrodes 516b, such that capacitor characteristics are provided.

Each of the external electrodes 530 preferably includes a base electrode layer 532 and a plated layer that covers the base electrode layer 532. The plated layer includes a lower plated layer 534 and an upper plated layer 536 that covers the lower plated layer 534.

The base electrode layer 532 includes a first base electrode layer 532a, a second base electrode layer 532b, a third base electrode layer 532c, and a fourth base electrode layer 532d. The first base electrode layer 532a, the second base electrode layer 532b, the third base electrode layer 532c, and the fourth base electrode layer 532d are formed by thin film layers including a plurality of thin film electrodes in order to improve performance.

The first base electrode layer 532a covers a portion of the first main surface 512a and a portion of the second main surface 512b, and a portion of the first surface 512c and a portion of the third surface 512e. The second base electrode layer 532b covers a portion of the first main surface 512a and a portion of the second main surface 512b, and a portion of the second surface 512d and a portion of the fourth surface 512f. The third base electrode layer 532c covers a portion of the first main surface 512a and a portion of the second main surface 512b, and a portion of the first surface 512c and a portion of the fourth surface 512f. The fourth base electrode layer 532d covers a portion of the first main surface 512a and a portion of the second main surface 512b, and a portion of the second surface 512d and a portion of the third surface 512e.

First, an example where the base electrode layers 532 are formed by fired layers will be described. The fired layers include a metal component and a glass component. The glass component includes at least one of, for example, B, Si, Ba, Mg, Al, Li, or the like. The metal component of the fired layers includes, for example, at least one of Cu, Ni, Ag, Pd, Ag—Pd alloys, Au, or the like. Furthermore, the fired layers may include a plurality of layers.

When the base electrode layers 532 are formed by fired layers, the base electrode layers may include the same type of components as the dielectric layers 514 and metal. In this case, for example, if the dielectric layers 514 include a CaZrO-based material, the same type of components are Ca and Zr.

The fired layers are formed by, for example, applying an electrically conductive paste including a glass component and a metal component to the multilayer body 512, and firing it. The fired layers may be formed by simultaneously firing a multilayer chip including the internal electrodes 516 and the dielectric layers 514 and the electrically conductive paste applied to the multilayer chip, or may be formed by firing the multilayer chip including the internal electrodes 516 and the dielectric layers 514 to obtain the multilayer body 512, and then applying the electrically conductive paste and firing it. When simultaneously firing the multilayer chip including the internal electrodes 516 and the dielectric layers 514 and the electrically conductive paste applied to the multilayer chip, it is preferable to add a dielectric component instead of the glass component, or to add both of a dielectric component and a glass component to form the fired layers.

The lower plated layer 534 includes a first lower plated layer 534a that covers the first base electrode layer 532a, a second lower plated layer 534b that covers the second base electrode layer 532b, a third lower plated layer 534c that covers the third base electrode layer 532c, and a fourth lower plated layer 534d that covers the fourth base electrode layer 532d.

The lower plated layer 534 includes, for example, at least one of Cu, Ni, Sn, Ag, Pd, an Ag—Pd alloy, Au, or the like.

The lower plated layer 534 is preferably Ni plating, for example. When the lower plated layer 534 is a Ni plated layer, it is possible to prevent the base electrode layer 532 from being eroded by solder when mounting the multilayer ceramic capacitor 510.

The thickness of the lower plated layer 534 is preferably, for example, about 1 μm or more and about 8 μm or less.

The upper plated layer 536 includes a first upper plated layer 536a that covers the first lower plated layer 534a, a second upper plated layer 536b that covers the second lower plated layer 534b, a third upper plated layer 536c that covers the third lower plated layer 534c, and a fourth upper plated layer 536d that covers the fourth lower plated layer 534d.

The upper plated layer 536 includes, for example, at least one of Cu, Ni, Sn, Ag, Pd, an Ag—Pd alloy, Au, or the like.

The upper plated layer 536 is preferably Sn plating, for example. When the upper plated layer 536 is Sn plating, it is possible to improve the wettability of solder when mounting the multilayer ceramic capacitor 10, and the multilayer ceramic capacitor 10 can be easily mounted.

The thickness of the upper plated layer 536 is preferably, for example, about 1 μm or more and about 8 μm or less.

A dimension in the first direction y of the multilayer ceramic capacitor 510 including the multilayer body 512 and the external electrode 530 is defined as an L dimension. The L dimension is preferably, for example, about 0.1 mm or more and about 6.0 mm or less. A dimension in the second direction z of the multilayer ceramic capacitor 510 including the multilayer body 512 and the external electrode 530 is defined as a W dimension. The W dimension is preferably, for example, about 0.1 mm or more and about 6.0 mm or less. A dimension in the lamination direction x of the multilayer ceramic capacitor 510 including the multilayer body 512 and the external electrode 530 is defined as a T dimension. The T dimension is preferably, for example, about 0.03 mm or more and about 1.8 mm or less. The dimension of the multilayer ceramic capacitor 510 preferably satisfies 7/10≤L/W≤ 10/7, for example. With such a configuration, the multilayer body 512 has a square or substantially square crystal shape, and thus the degrees of freedom in mounting is improved.

In the second example embodiment, in the multilayer ceramic electronic component 500, the joining electrode 540 electrically joins the first external electrode 530a and the second external electrode 530b of the multilayer ceramic capacitor 510 on the first main surface 512a of the multilayer body 512. Further, the joining electrode 540 may electrically join the third external electrode 530c and the fourth external electrode 530d, rather than electrically joining the first external electrode 530a and the second external electrode 530b of the multilayer ceramic capacitor 510.

The joining electrode 540 includes a joining base electrode 542, a joining lower plated layer 544 covering the joining base electrode 542, and a joining upper plated layer 546 covering the joining lower plated layer 544. Further, the joining electrode 540 may include only the joining base electrode 542.

When the DC resistance of the multilayer ceramic capacitor 510 is defined as Rdc1 and the DC resistance of the joining electrode 540 is defined as Rdc3, it is preferred that Rdc1≤Rdc3 is satisfied, for example.

As described above, example embodiments of the present invention are disclosed in the above description, but the present invention is not limited thereto. That is, various modifications can be made to the example embodiments described above with respect to mechanisms, shapes, materials, quantities, positions, or arrangements without departing from the scope and spirit of the present invention, and such modifications are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic electronic component comprising:
a multilayer ceramic capacitor including:
a multilayer body including a first main surface and a second main surface opposed to each other in a lamination direction, a first surface and a second surface opposed to each other in a first direction orthogonal or substantially orthogonal to the lamination direction, and a third surface and a fourth surface opposed to each other in a second direction orthogonal or substantially orthogonal to the lamination direction and the first direction; and
at least four external electrodes on any one of the first surface, the second surface, the third surface, or the fourth surface; and
a joining electrode on either one of the first main surface or the second main surface and electrically joining at least two external electrodes of a same potential among the at least four external electrodes; wherein
when a DC resistance of the multilayer ceramic capacitor is defined as Rdc1 and a DC resistance of the joining electrode is defined as Rdc3, Rdc1≤Rdc3 is satisfied.

2. The multilayer ceramic electronic component according to claim 1, wherein the Rdc3 is about 1.0 times or more and about 5.0 times or less of the Rdc1.

3. The multilayer ceramic electronic component according to claim 1, wherein a thickness of the joining electrode in the lamination direction is thinner than a thickness of an external electrode of the at least four external electrodes on a same plane as the joining electrode in the lamination direction.

4. The multilayer ceramic electronic component according to claim 1, wherein
each of the at least four external electrodes includes a base electrode and a plated layer;
the joining electrode includes a joining base electrode and a joining plated layer; and
a porosity of the joining base electrode is higher than a porosity of the base electrode on a same plane as the joining base electrode, and the plated layer and the joining plated layer include a same plating.

5. The multilayer ceramic electronic component according to claim 1, wherein
each of the at least four external electrodes includes a base electrode and a plated layer;
the joining electrode includes a sputtered electrode; and
a porosity of the joining electrode is lower than a porosity of the base electrode on a same plane as the joining electrode.

6. The multilayer ceramic electronic component according to claim 4, wherein the joining plated layer includes a joining lower plated layer on the joining base electrode, and a joining upper plated layer on the joining lower plated layer.

7. The multilayer ceramic electronic component according to claim 6, wherein the joining lower plated layer includes a Ni plated layer.

8. The multilayer ceramic electronic component according to claim 6, wherein the joining upper plated layer includes an Sn plated layer.

9. The multilayer ceramic electronic component according to claim 1, wherein a main component of the joining electrode includes Cu, NiCr, or NiCu.

10. The multilayer ceramic electronic component according to claim 4, wherein the base electrode includes at least one of a fired layer, an electrically conductive resin layer, or a thin film layer.

11. The multilayer ceramic electronic component according to claim 4, wherein the base electrode includes a metal component and a glass component.

12. The multilayer ceramic electronic component according to claim 11, wherein the metal component includes at least one of Cu, Ni, Ag, Pd, Ag—Pd alloys, or Au.

13. The multilayer ceramic electronic component according to claim 11, wherein the glass component includes at least one of B, Si, Ba, Mg, Al, or Li.

14. The multilayer ceramic electronic component according to claim 4, wherein the base electrode includes a plated layer including at least one of Cu, Ni, Sn, Pd, Au, Ag, Bi, or Zn, or the like, or an alloy at least one of Cu, Ni, Sn, Pd, Au, Ag, Bi, or Zn.

15. The multilayer ceramic electronic component according to claim 14, wherein a metal ratio per unit area of the plated layer is about 99% by volume or more.

16. The multilayer ceramic electronic component according to claim 5, wherein the base electrode includes a metal component and a glass component.

17. The multilayer ceramic electronic component according to claim 16, wherein the metal component includes at least one of Cu, Ni, Ag, Pd, Ag—Pd alloys, or Au.

18. The multilayer ceramic electronic component according to claim 16, wherein the glass component includes at least one of B, Si, Ba, Mg, Al, or Li.

19. The multilayer ceramic electronic component according to claim 5, wherein the base electrode includes a plated layer including at least one of Cu, Ni, Sn, Pd, Au, Ag, Bi, or Zn, or the like, or an alloy at least one of Cu, Ni, Sn, Pd, Au, Ag, Bi, or Zn.

20. The multilayer ceramic electronic component according to claim 19, wherein a metal ratio per unit area of the plated layer is about 99% by volume or more.
